(19) United States
(12) Patent Application Publication
(10) Pub. No.: US 2024/0399468 A1
(43) Pub. Date: Dec. 5, 2024

(54) SELF-ADJUSTING POCKET HOLE JIG SYSTEM

(71) Applicant: Kreg Enterprises, Inc., Ankeny, IA (US)

(72) Inventors: Andrew Lyons, Grimes, IA (US); Shelby Strempke, Kelley, IA (US); Ethan Andersen, Bondurant, IA (US); Timothy J. Forbes, Ankeny, IA (US); Scott Schaaf, Ankeny, IA (US); Derek Steelman, Ankeny, IA (US); Kevin Shin, San Diego, CA (US)

(21) Appl. No.: 18/806,893

(22) Filed: Aug. 16, 2024

Related U.S. Application Data
(63) Continuation-in-part of application No. 17/572,784, filed on Jan. 11, 2022.
Application No. 17/572,784 is a continuation of application No. 16/788,440, filed on Feb. 12, 2020, now Pat. No. 11,364,551.
(63) Continuation-in-part of application No. 18/544,754, filed on Dec. 19, 2023.
(60) Provisional application No. 62/804,847, filed on Feb. 13, 2019.
(60) Provisional application No. 63/520,146, filed on Aug. 17, 2023.
(60) Provisional application No. 63/434,144, filed on Dec. 21, 2022.

(51) Int. Cl. B23B 47/28; B23B 49/00; B23Q 3/06; B23Q 11/00

(52) U.S. Cl. CPC B23B 47/287; B23Q 3/06; B23Q 11/0046; B23B 49/005; B23B 2247/10; B23B 2247/12; B23B 2260/004; B23B 2270/30

(57) ABSTRACT

A self-adjusting pocket hole jig system is presented having a base, an upright assembly operably connected to the base, a clamp and drill guide assembly operably connected to the upright assembly, and an actuator assembly operably connected to the clamp and drill guide assembly. The clamp and drill guide assembly is configured to move along the upright assembly in response to movement of a handle of the actuator assembly upward and downward. Movement of the handle downward automatically adjusts the height of the clamp and drill guide assembly based on thickness of the workpiece for drilling of a pocket hole. In one or more arrangements, rotation of the handle downward from a non-clamping position to a clamping position simultaneously locks the clamp and drill guide assembly in place along the upward assembly and clamps the workpiece between the clamp and drill guide assembly and a backstop of the base.

### CROSS REFERENCE TO RELATED APPLICATIONS

This application is a continuation-in-part application of U.S. patent application Ser. No. 17/572,784 filed on Jan. 11, 2022, which is a continuation of U.S. patent application Ser. No. 16/788,440 filed on Feb. 12, 2020 and issued as U.S. Pat. No. 11,364,551, which claims priority to U.S. Provisional Application No. 62/804,847 filed on Feb. 13, 2019, each of which is fully incorporated by reference herein. This application is also a continuation-in-part application of U.S. patent application Ser. No. 18/544,754 filed on Dec. 19, 2023, which claims priority to U.S. Provisional Application No. 63/434,144 filed on Dec. 21, 2022, each of which is fully incorporated by reference herein. This application also claims priority to U.S. Provisional Application No. 63/520,146 filed Aug. 17, 2023 and titled SELF-ADJUSTING POCKET HOLE JIG SYSTEM, which is fully incorporated by reference herein.

### FIELD OF THE DISCLOSURE

This disclosure relates generally to jig systems for holding workpieces. More specifically and without limitation, this disclosure relates generally to improved drilling jig systems that facilitate faster and/or easier clamping of workpieces.

### OVERVIEW OF THE DISCLOSURE

Pocket hole wood joinery involves joining boards by inserting a fastener at an angle through the edge of one workpiece into an adjoining workpiece, thereby joining the two workpieces together. Such joints are commonly used for face frames, cabinet boxes, leg-to-rail joinery in chairs and tables, and so forth. Drill guides or jigs are used to drill the holes through which the fasteners or pocket screws are inserted into the adjoining workpiece.

To facilitate the formation of pocket hole joinery, Applicant, Kreg Tool Company offers a line of pocket hole jigs. These pocket hole jigs are configured to clamp a workpiece in place and help guide a stepped drill bit at an angle into a workpiece thereby forming a pocket hole in the workpiece. The pocket hole formed by this process is configured to receive a screw that is used to screw two workpieces together.

Existing jigs for use forming pocket hole joinery have a variety of configurations and operate in a variety of manners. These configurations and manners of operation leave much to be desired. In addition, all of the existing pocket hole jigs available have deficiencies and therefore are not well suited for various applications, they are unnecessarily time consuming or they are unnecessarily inefficient to use.

For the reasons stated above, and for other reasons stated below which will become apparent to those skilled in the art upon reading and understanding the disclosure, there is a need in the art for a self-adjusting pocket hole jig system that improves upon the state of the art.

Thus, it is an object of at least one embodiment of the disclosure is to provide a self-adjusting pocket hole jig system that improves upon the state of the art.

Another object of at least one embodiment of the disclosure is to provide a self-adjusting pocket hole jig system that is easy to use.

Yet another object of at least one embodiment of the disclosure is to provide a self-adjusting pocket hole jig system that is efficient.

Another object of at least one embodiment of the disclosure is to provide a self-adjusting pocket hole jig system that can be used with any type of workpiece.

Yet another object of at least one embodiment of the disclosure is to provide a self-adjusting pocket hole jig system that is cost effective.

Another object of at least one embodiment of the disclosure is to provide a self-adjusting pocket hole jig system that forms accurate pocket holes.

Yet another object of at least one embodiment of the disclosure is to provide a self-adjusting pocket hole jig system that is safe to use.

Another object of at least one embodiment of the disclosure is to provide a self-adjusting pocket hole jig system that has a durable design.

Yet another object of at least one embodiment of the disclosure is to provide a self-adjusting pocket hole jig system that has a long useful life.

Another object of at least one embodiment of the disclosure is to provide a self-adjusting pocket hole jig system that provides additional functionality for pocket hole jigs and pocket hole joinery.

Yet another object of at least one embodiment of the disclosure is to provide a self-adjusting pocket hole jig system that has a wide variety of uses.

Another object of at least one embodiment of the disclosure is to provide a self-adjusting pocket hole jig system that has a wide variety of applications.

Yet another object of at least one embodiment of the disclosure is to provide a self-adjusting pocket hole jig system that provides cost savings to a user.

Another object of at least one embodiment of the disclosure is to provide a self-adjusting pocket hole jig system that is relatively inexpensive.

Yet another object of at least one embodiment of the disclosure is to provide a self-adjusting pocket hole jig system that provides value.

Another object of at least one embodiment of the disclosure is to provide a self-adjusting pocket hole jig system that prevents or reduces relative movement between the pocket hole jig and the workpiece.

Yet another object of at least one embodiment of the disclosure is to provide a self-adjusting pocket hole jig system that reduces the amount of clamping pressure required to adequately clamp a pocket hole jig to a workpiece.

Another object of at least one embodiment of the disclosure is to provide a self-adjusting pocket hole jig system that facilitates the formation of aesthetically pleasing finished products.

Yet another object of at least one embodiment of the disclosure is to provide a self-adjusting pocket hole jig system that provides a clamping with movement of a handle in a single plane.

Another object of at least one embodiment of the disclosure is to provide a self-adjusting pocket hole jig system that facilitates easier clamping.

Yet another object of at least one embodiment of the disclosure is to provide a self-adjusting pocket hole jig system that facilitates raising and lowering of the drill guide assembly with movement of the handle in a single plane.

Another object of at least one embodiment of the disclosure is to provide a self-adjusting pocket hole jig system that facilitates easy release of the clamping mechanism.

Yet another object of at least one embodiment of the disclosure is to provide a self-adjusting pocket hole jig system that facilitates easy return of the clamping mechanism to a non-clamping position.

Another object of at least one embodiment of the disclosure is to provide a self-adjusting pocket hole jig system that facilitates easy adjustment of the clamping pressure.

Yet another object of at least one embodiment of the disclosure is to provide a self-adjusting pocket hole jig system that facilitates stable placement when used horizontally.

Another object of at least one embodiment of the disclosure is to provide a self-adjusting pocket hole jig system that facilitates stable placement when used vertically.

Yet another object of at least one embodiment of the disclosure is to provide a self-adjusting pocket hole jig system that facilitates easy removal of chips and debris during use.

Another object of at least one embodiment of the disclosure is to provide a self-adjusting pocket hole jig system that is comfortable to use.

Yet another object of at least one embodiment of the disclosure is to provide a self-adjusting pocket hole jig system that is more stable than other pocket hole jigs.

Another object of at least one embodiment of the disclosure is to provide a self-adjusting pocket hole jig system that facilitates automatic return of the clamping assembly to a non-clamping position.

Yet another object of at least one embodiment of the disclosure is to provide a self-adjusting pocket hole jig system that facilitates spring loaded return of the clamping assembly to a non-clamping position.

Another object of at least one embodiment of the disclosure is to provide a self-adjusting pocket hole jig system that improves the ergonomics of use.

Yet another object of at least one embodiment of the disclosure is to provide a self-adjusting pocket hole jig system that easily adjusts to workpieces of various thicknesses.

Another object of at least one embodiment of the disclosure is to provide a self-adjusting pocket hole jig system that adjusts the drill guide assembly to the optimum position for each workpiece.

Yet another object of at least one embodiment of the disclosure is to provide a self-adjusting pocket hole jig system that consistently applies the same clamping pressure regardless of workpiece thickness.

Another object of at least one embodiment of the disclosure is to provide a self-adjusting pocket hole jig system that improves the intuitiveness of drilling pocket hole jigs.

Yet another object of at least one embodiment of the disclosure is to provide a self-adjusting pocket hole jig system that improves the usability of pocket hole jigs.

Another object of at least one embodiment of the disclosure is to provide a self-adjusting pocket hole jig system that eliminates the ability to choose incorrect wood thickness.

Yet another object of at least one embodiment of the disclosure is to provide a self-adjusting pocket hole jig system that reduces set-up time.

Another object of at least one embodiment of the disclosure is to provide a self-adjusting pocket hole jig system that provides a single touch point for clamping and adjusting the position of the drill guide assembly.

Yet another object of at least one embodiment of the disclosure is to provide a self-adjusting pocket hole jig system that provides convenient woodchip, dust and debris removal.

Another object of at least one embodiment of the disclosure is to provide a self-adjusting pocket hole jig system that provides easy removal and replacement of drill guide blocks.

These and other objects, features, or advantages of at least one embodiment will become apparent from the specification, figures and claims.

### SUMMARY

In one or more arrangements, a self-adjusting pocket hole jig system is presented having a base, an upright assembly operably connected to the base, a clamp and drill guide assembly operably connected to the upright assembly, and an actuator assembly operably connected to the clamp and drill guide assembly. In one or more arrangements, the clamp and drill guide assembly is configured to move along the upright assembly in response to movement of a handle of the actuator assembly in a non-clamping position between a raised position and a lowered position. In one or more arrangements, movement of the handle downward automatically adjusts the height of the clamp and drill guide assembly based on thickness of the workpiece for drilling of a pocket hole. In one or more arrangements, rotation of the handle downward from a non-clamping position to a clamping position simultaneously locks the clamp and drill guide assembly in place along the upward assembly and clamps the workpiece between the clamp and drill guide assembly and a backstop of the base.

### BRIEF DESCRIPTION OF THE DRAWINGS

FIG. 1 shows a left side view of a self-adjusting pocket hole jig system, in accordance with one or more arrangements; the view showing a cutaway cross section of an upright assembly; the view showing a clamp and drill guide assembly positioned in a raised position on the upright assembly, the view showing a handle in a non-clamping position.

FIG. 2 shows a left side view of a self-adjusting pocket hole jig system, in accordance with one or more arrangements; the view showing a cutaway cross section of the upright assembly; the view showing the clamp and drill guide assembly in a lowered position on the upright assembly, the view showing the handle in a tiled clamping position.

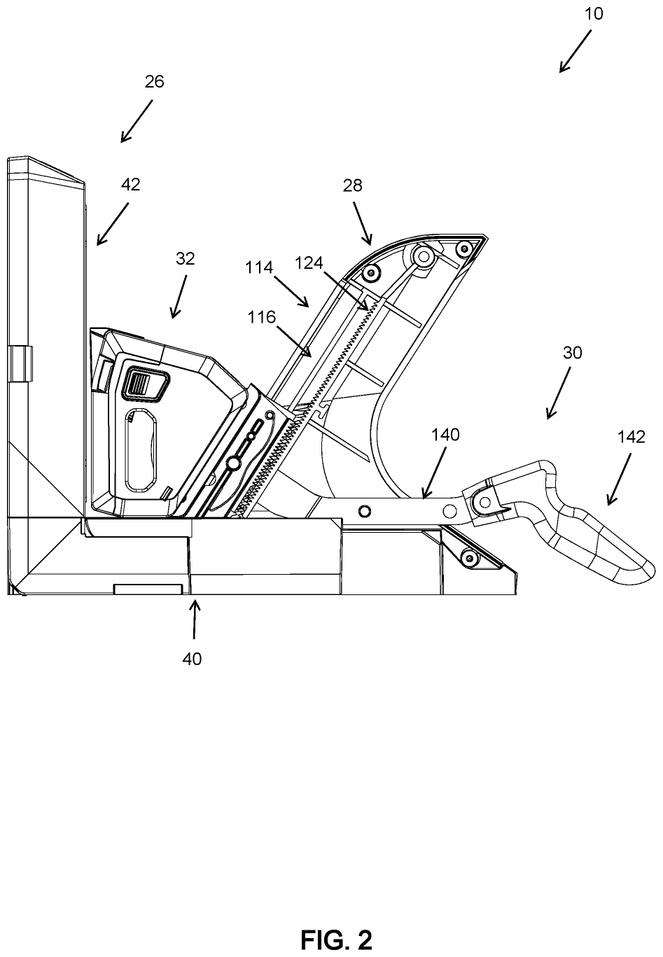

FIG. 3 shows a left side view of a self-adjusting pocket hole jig system, in accordance with one or more arrangements; the view showing a cutaway cross section of the upright assembly; the view showing the clamp and drill guide assembly in a raised position, the view showing a handle in a non-clamping position; the view showing a workpiece positioned for clamping by the system.

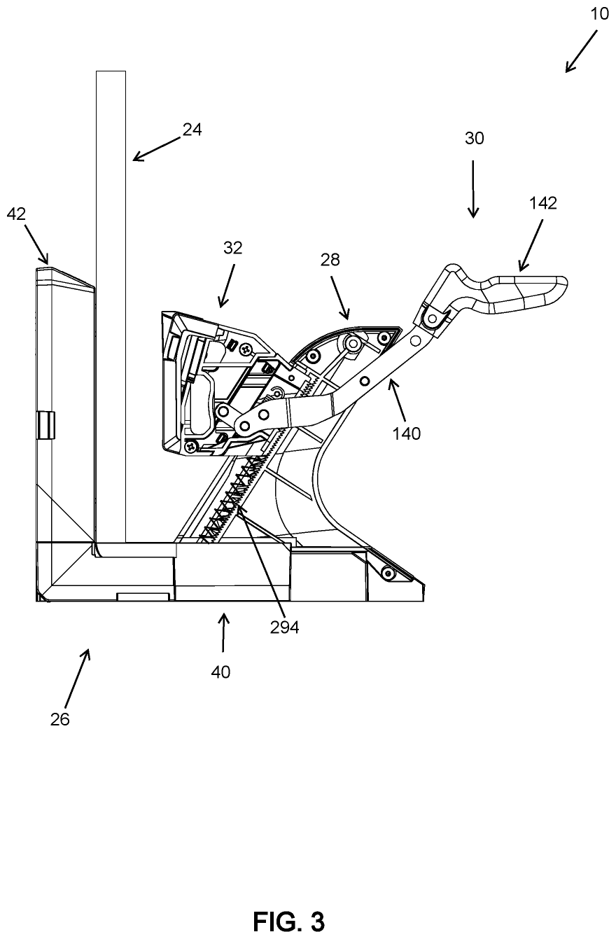

FIG. 4 shows a left side view of a self-adjusting pocket hole jig system, in accordance with one or more arrangements; the view showing a cutaway cross section of the upright assembly; the view showing the clamp and drill guide assembly in a lowered position, the view showing the handle in an intermediate tiled position, with a workpiece in position for clamping by the clamp and drill guide assembly.

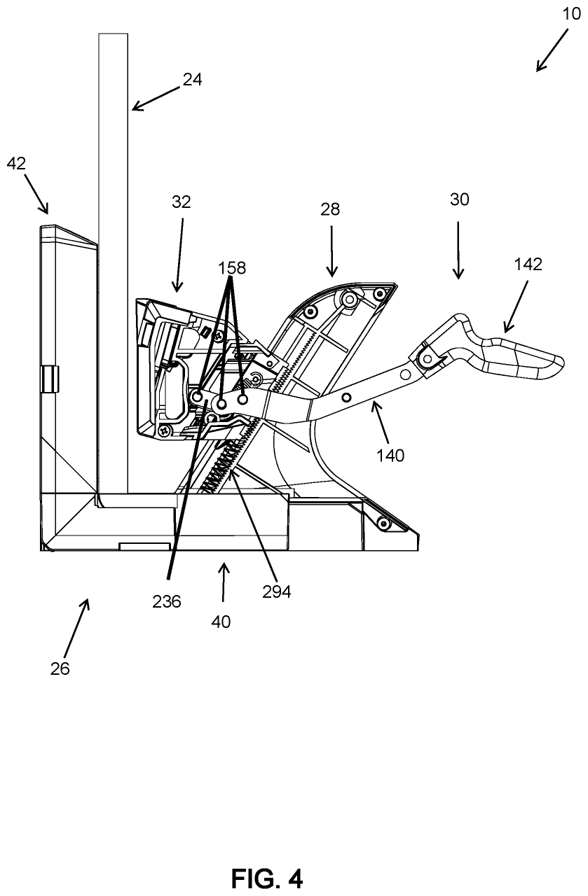

FIG. 5 shows a left side view of a self-adjusting pocket hole jig system, in accordance with one or more arrangements; the view showing a cutaway cross section of the upright assembly; the view showing the clamp and drill guide assembly in a lowered position, the view showing the handle in a tiled clamped position, with a workpiece being clamped by the clamp and drill guide assembly.

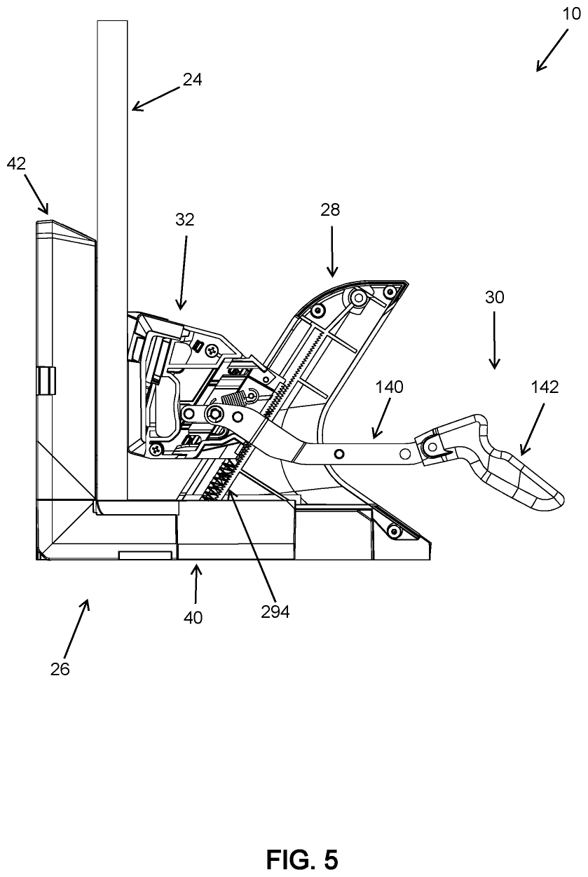

FIG. 6 shows a left side view of a self-adjusting pocket hole jig system, in accordance with one or more arrangements; the view showing a cutaway cross section of an upright assembly; the view showing the clamp and drill guide assembly in a lowered position, the view showing the handle in a tiled clamped position, with a workpiece being clamped by the clamp and drill guide assembly.

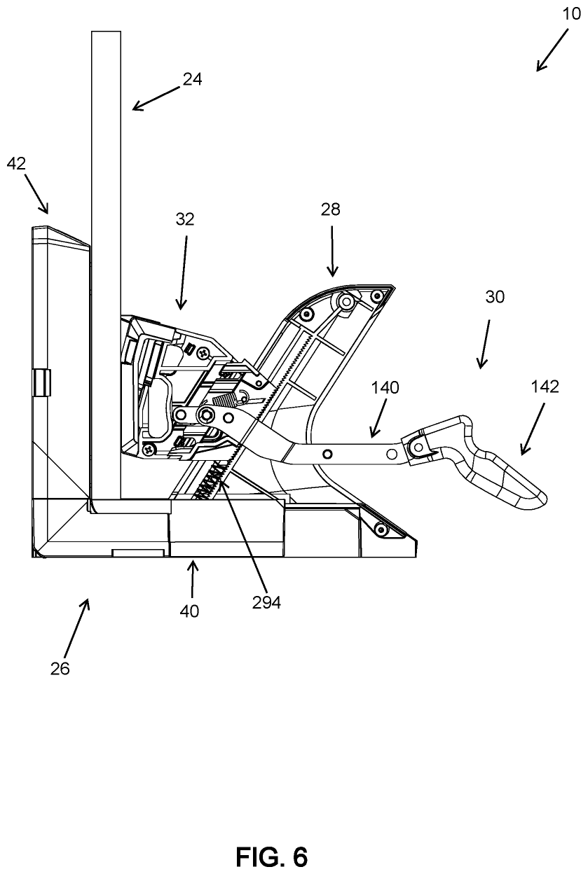

FIG. 7 shows a left side view of a self-adjusting pocket hole jig system, in accordance with one or more arrangements; the view showing a cutaway cross section of the upright assembly; the view showing the clamp and drill guide assembly in a lowered position, the view showing the handle in a tiled clamped position, with a workpiece being clamped by the clamp and drill guide assembly.

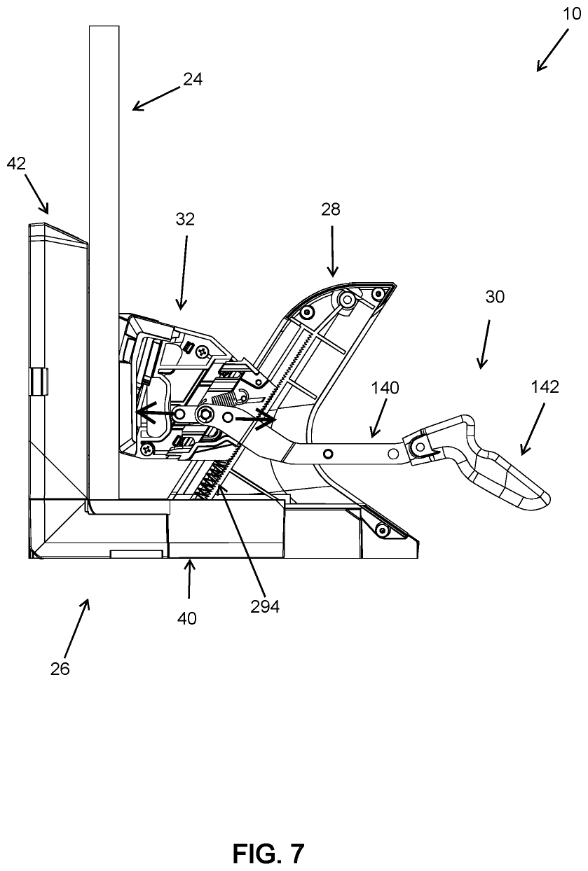

FIG. 8 shows a right side view of a self-adjusting pocket hole jig system, in accordance with one or more arrangements; the view showing a cutaway cross section of the upright assembly; the view showing the clamp and drill guide assembly positioned in a raised position on the upright assembly, the view showing a handle in a non-clamping position.

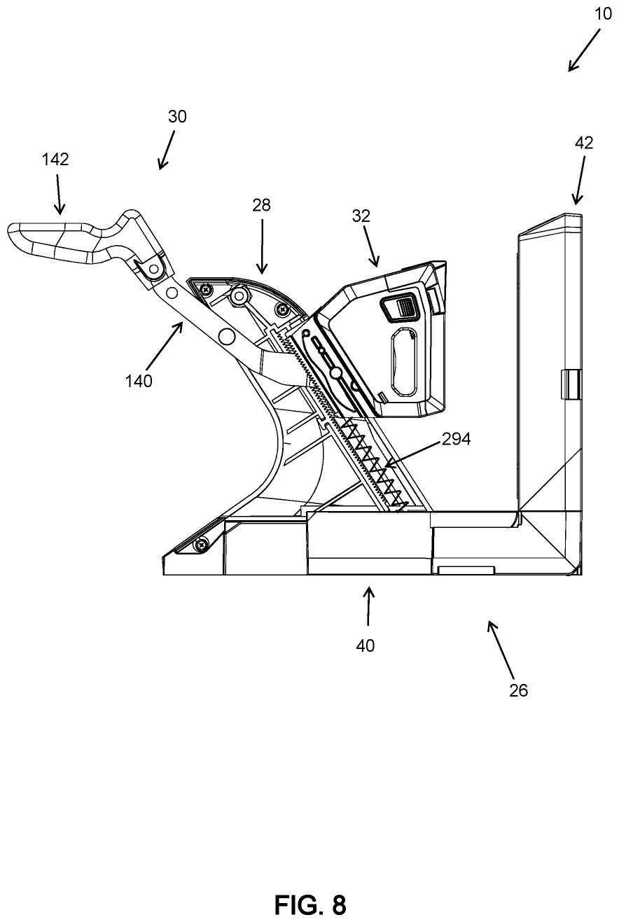

FIG. 9 shows a right side view of a self-adjusting pocket hole jig system, in accordance with one or more arrangements; the view showing a cutaway cross section of the upright assembly; the view showing the clamp and drill guide assembly in a lowered position, the view showing the handle in the tiled clamped position, with a workpiece being clamped by the clamp and drill guide assembly.

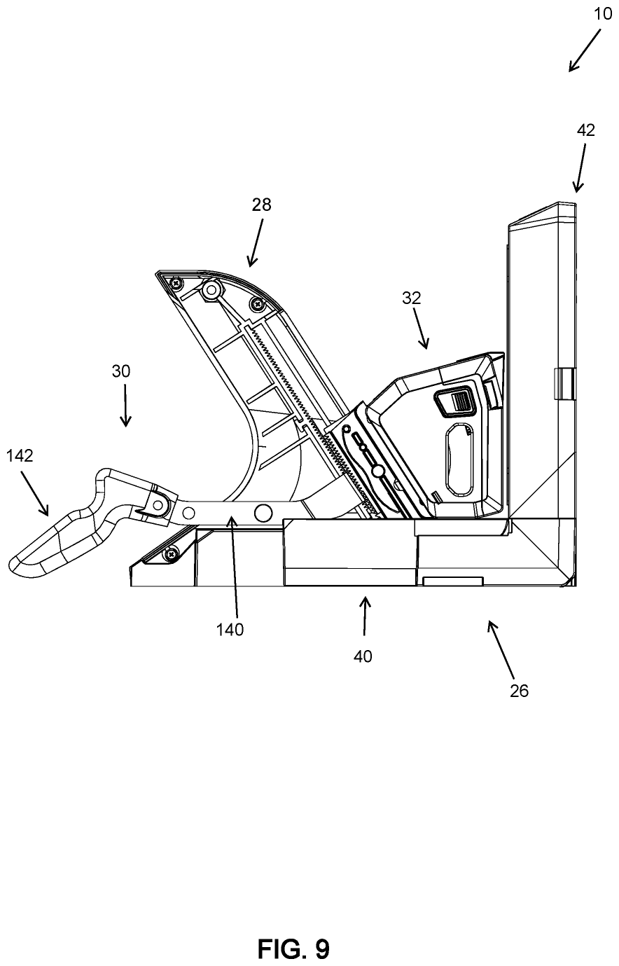

FIG. 10 shows an upper rear left perspective view of a self-adjusting pocket hole jig system, in accordance with one or more arrangements; he view showing a cutaway cross section of the upright assembly; the view showing the clamp and drill guide assembly positioned in a raised position on the upright assembly, the view showing a handle in a non-clamping position.

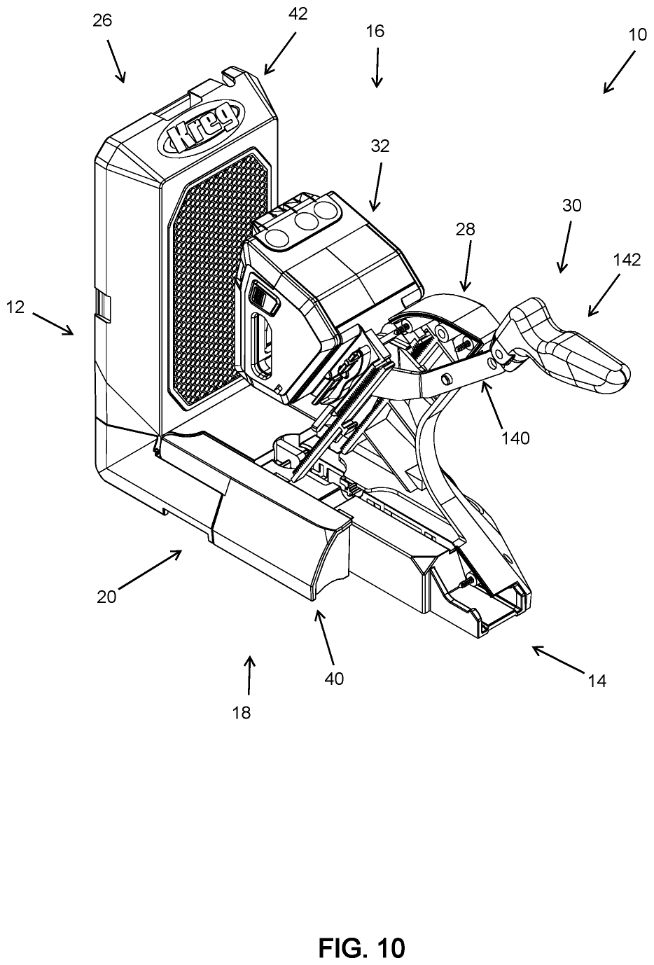

FIG. 11 shows an upper rear left perspective view of a self-adjusting pocket hole jig system, in accordance with one or more arrangements; he view showing a cutaway cross section of the upright assembly; the view showing the clamp and drill guide assembly in a lowered position, the view showing the handle in the tiled clamped position, with a workpiece being clamped by the clamp and drill guide assembly.

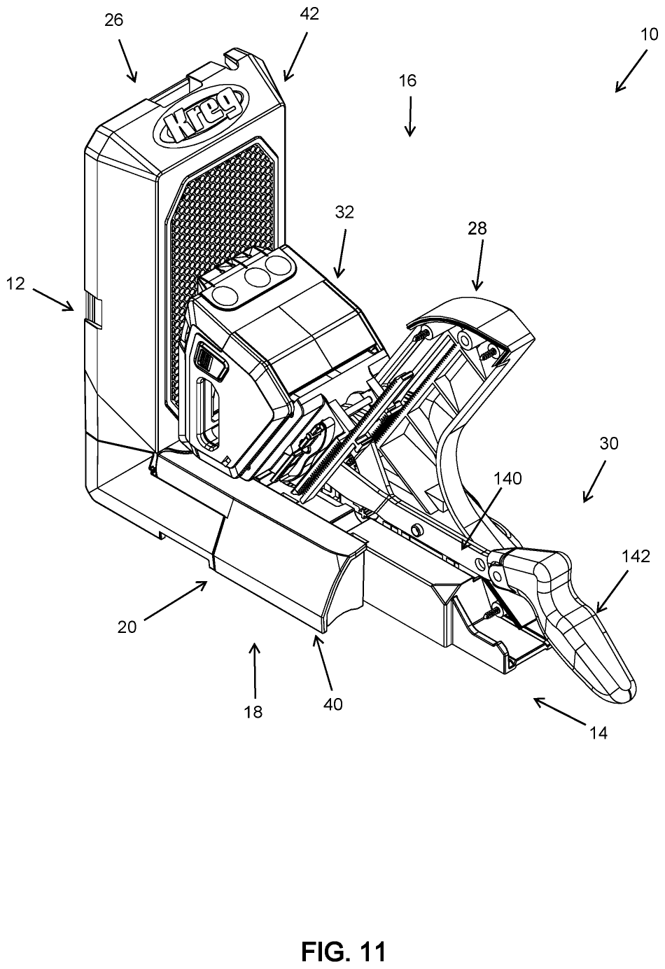

FIG. 12 shows an upper rear perspective view of a self-adjusting pocket hole jig system, in accordance with one or more arrangements; the view showing the clamp and drill guide assembly positioned in a raised position on the upright assembly, the view showing a handle in a non-clamping position.

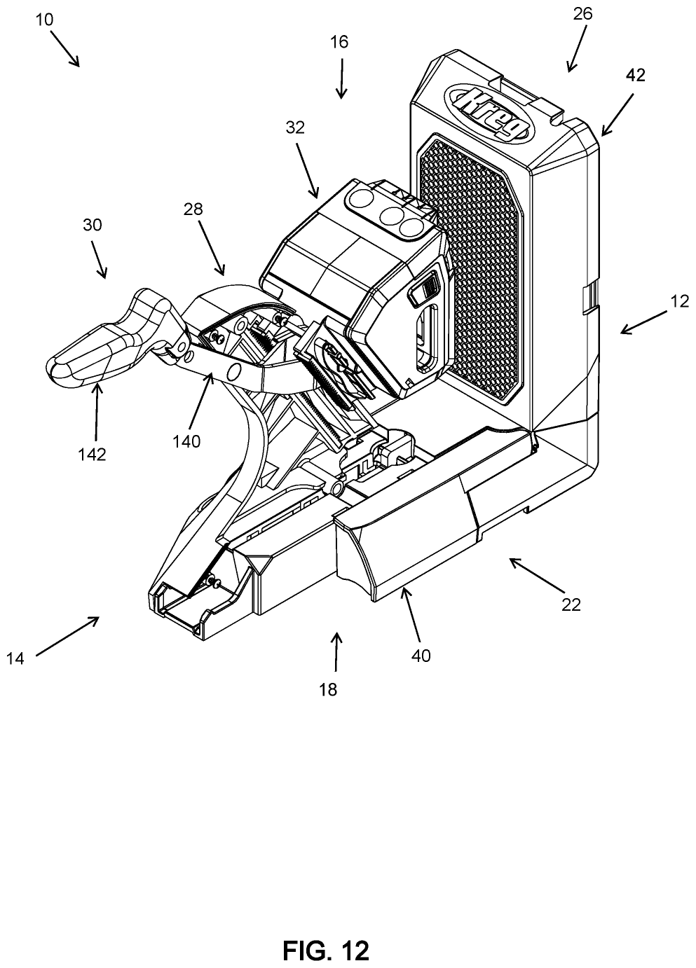

FIG. 13 shows an upper right perspective view of a self-adjusting pocket hole jig system, in accordance with one or more arrangements; the view showing the clamp and drill guide assembly in a lowered position, the view showing the handle in the tiled clamped position, with a workpiece being clamped by the clamp and drill guide assembly.

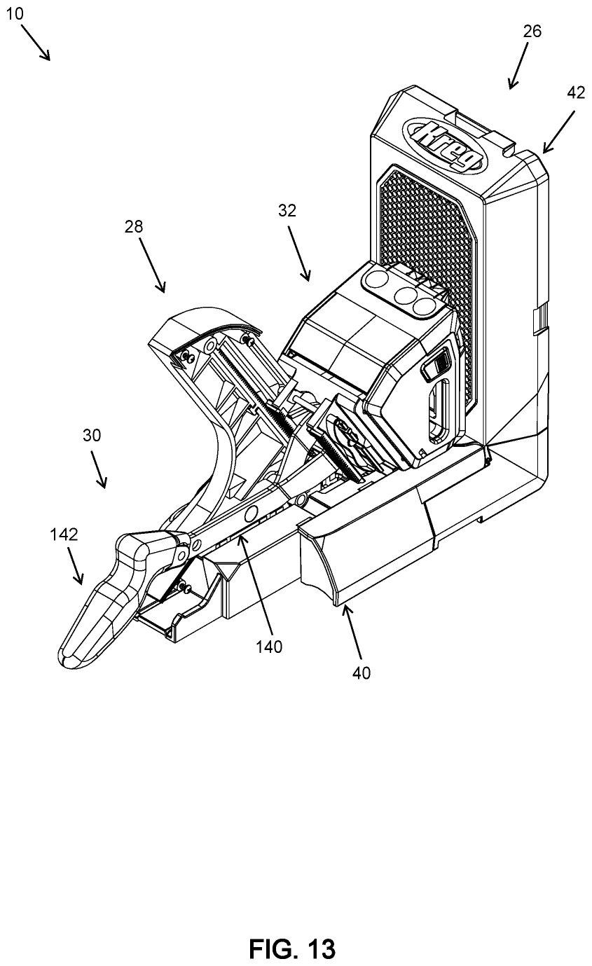

FIG. 14 shows an upper rear left perspective view of a self-adjusting pocket hole jig system, in accordance with one or more arrangements; the view showing the clamp and drill guide assembly positioned in a raised position on the upright assembly, the view showing a handle in a non-clamping position; the view showing a vacuum attachment connected with the clamp and drill guide assembly.

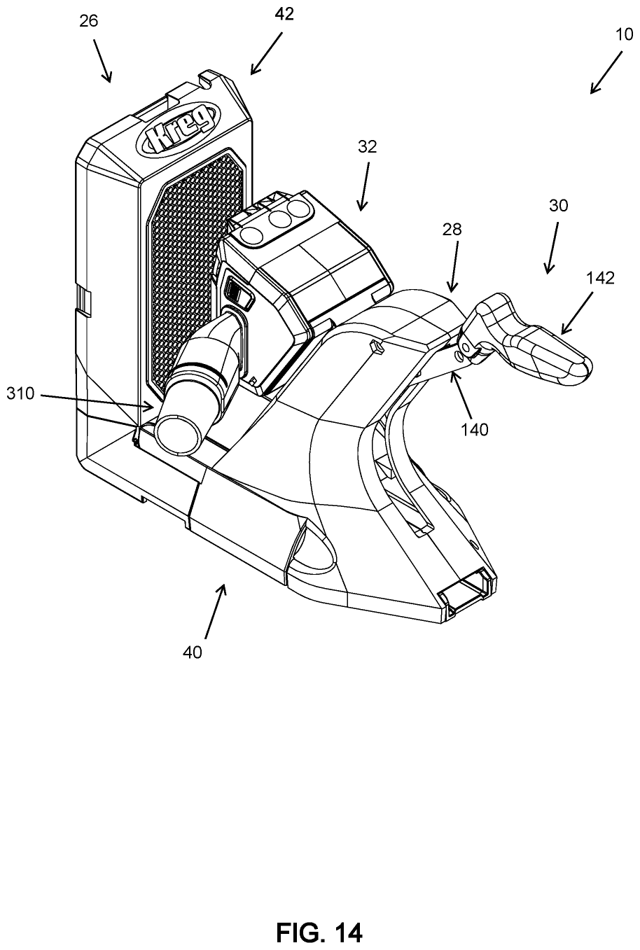

FIG. 15 shows an upper rear right perspective view of a self-adjusting pocket hole jig system, in accordance with one or more arrangements; the view showing the clamp and drill guide assembly positioned in a raised position on the upright assembly, the view showing a handle in a non-clamping position; the view showing a vacuum attachment connected with the clamp and drill guide assembly.

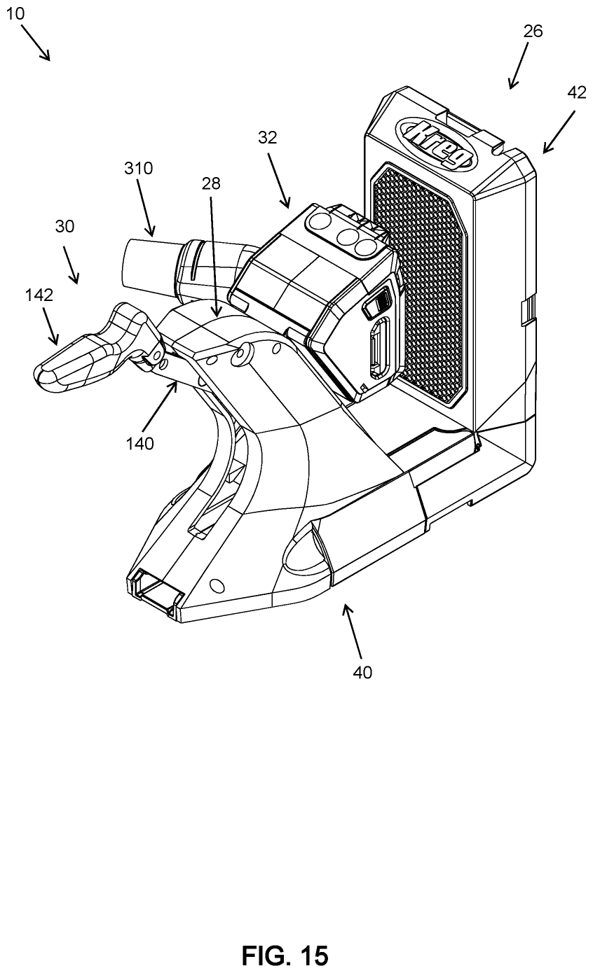

FIG. 16 shows an upper front left perspective view of a self-adjusting pocket hole jig system, in accordance with one or more arrangements; the view showing the clamp and drill guide assembly positioned in a raised position on the upright assembly, the view showing a handle in a non-clamping position; the view showing a vacuum attachment connected with the clamp and drill guide assembly.

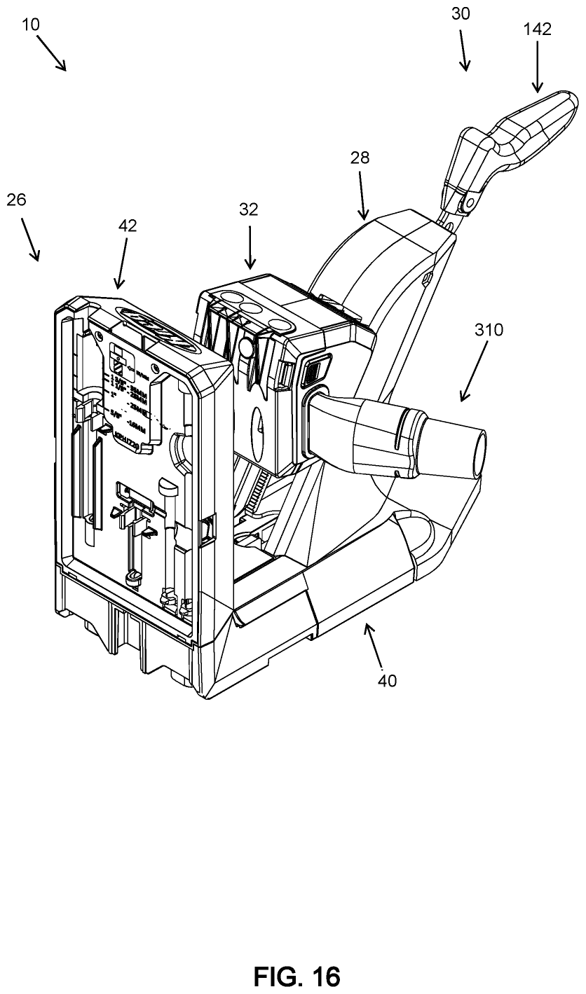

FIG. 17 shows an upper front right perspective view of a self-adjusting pocket hole jig system, in accordance with one or more arrangements; the view showing the clamp and drill guide assembly positioned in a raised position on the upright assembly, the view showing a handle in a non-clamping position; the view showing a vacuum attachment connected with the clamp and drill guide assembly.

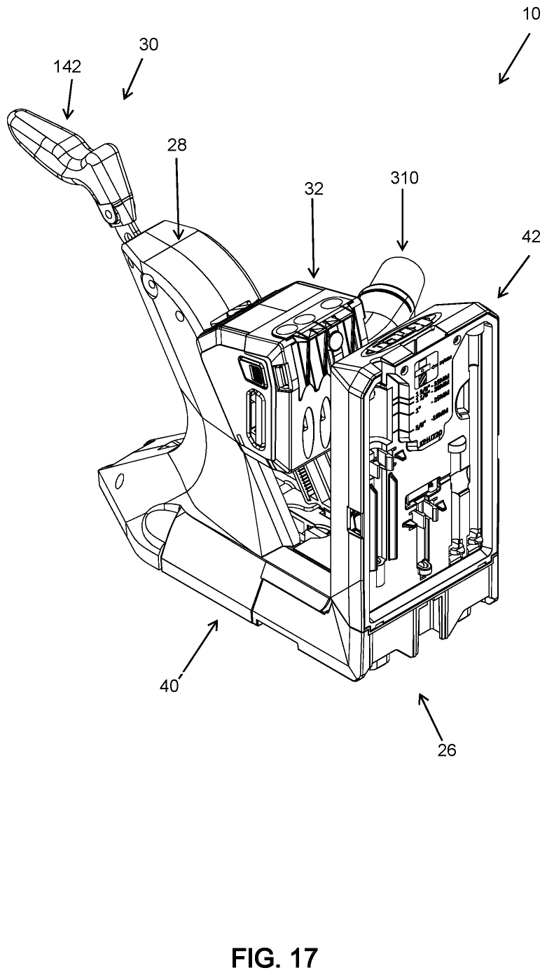

FIG. 18 shows a lower front right perspective view of a self-adjusting pocket hole jig system, in accordance with one or more arrangements; the view showing a cutaway cross section of the upright assembly; the view showing the clamp and drill guide assembly in a raised position, the view showing a handle in a non-clamping position.

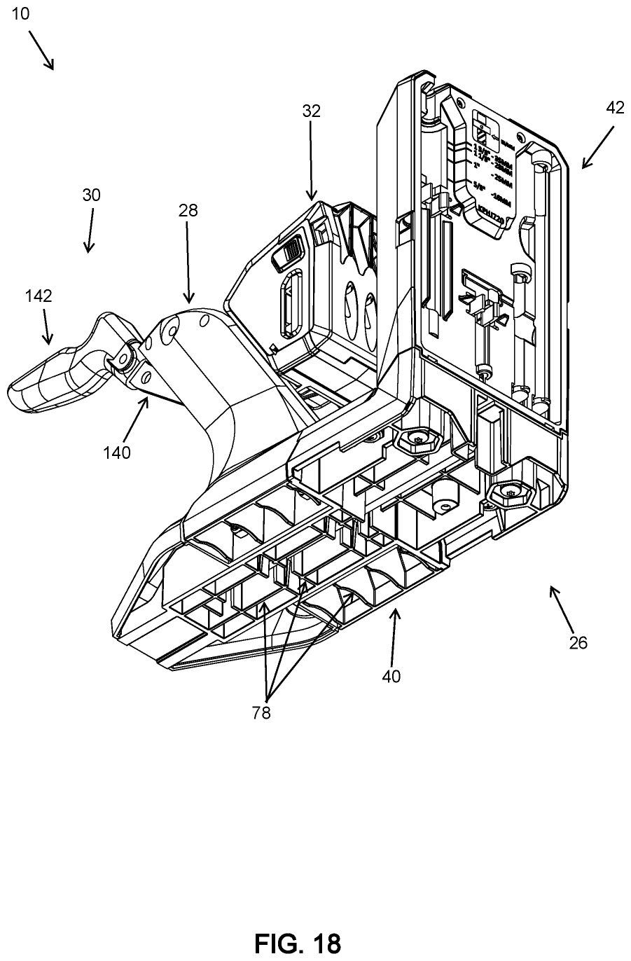

FIG. 19 shows a left side view of a self-adjusting pocket hole jig system, in accordance with one or more arrangements; the view showing the clamp and drill guide assembly in a raised position, the view showing a handle in a non-clamping position; the view showing a workpiece positioned for clamping by the system.

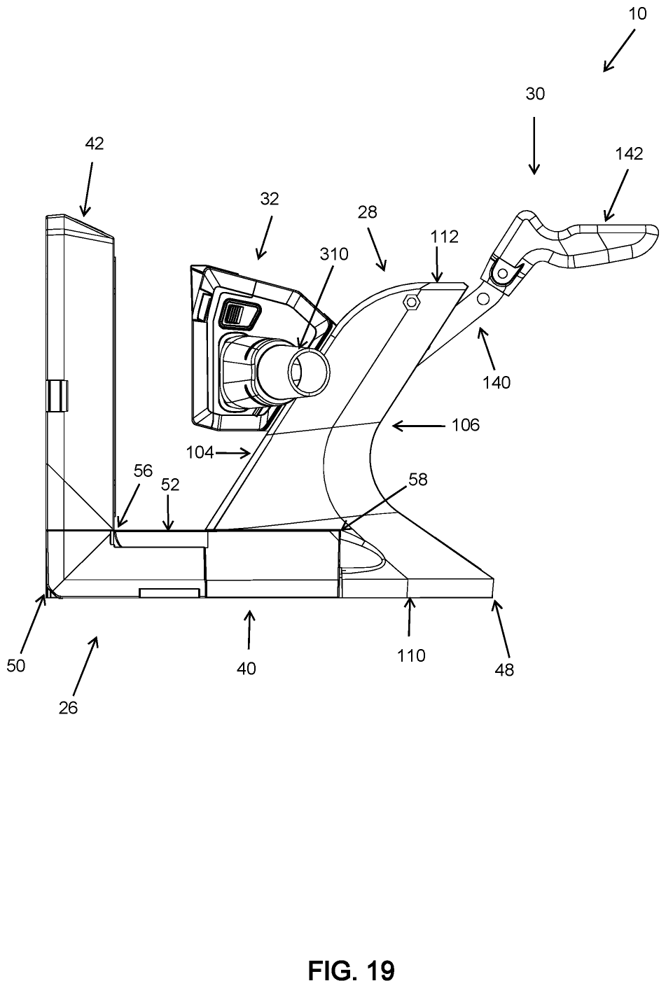

FIG. 20 shows a right side view of a self-adjusting pocket hole jig system, in accordance with one or more arrangements; the view showing the clamp and drill guide assembly in a raised position, the view showing a handle in a non-clamping position; the view showing a workpiece positioned for clamping by the system.

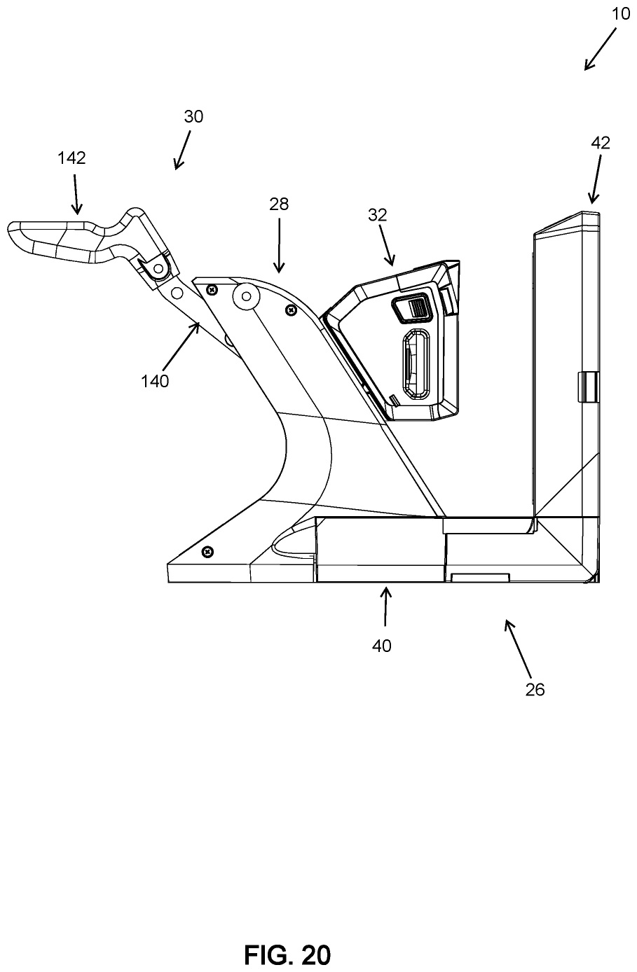

FIG. 21 shows a top view of a self-adjusting pocket hole jig system, in accordance with one or more arrangements; the view showing the clamp and drill guide assembly in a lowered position, the view showing a handle in a tiled clamped position.

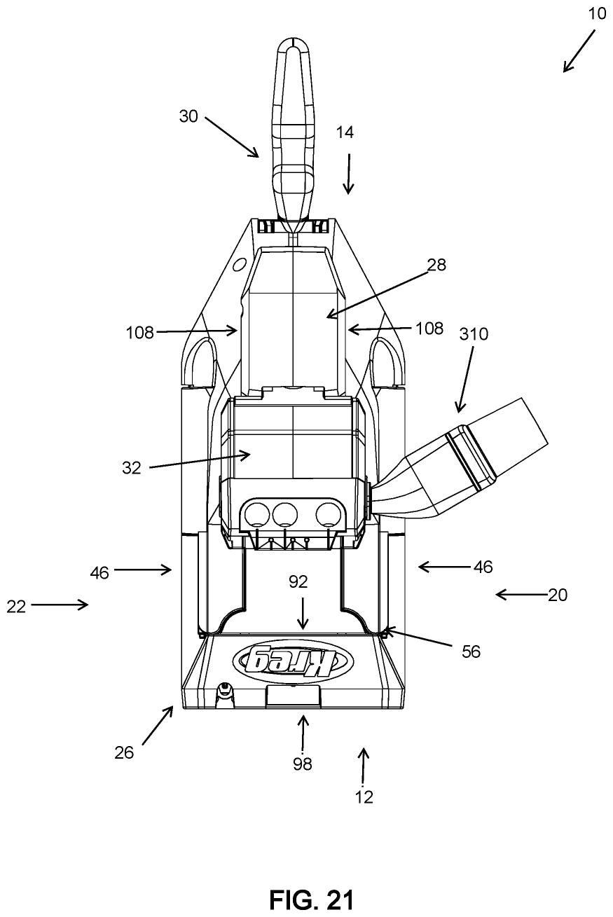

FIG. 22 shows a bottom view of a self-adjusting pocket hole jig system, in accordance with one or more arrangements; the view showing a handle in a tiled clamped position.

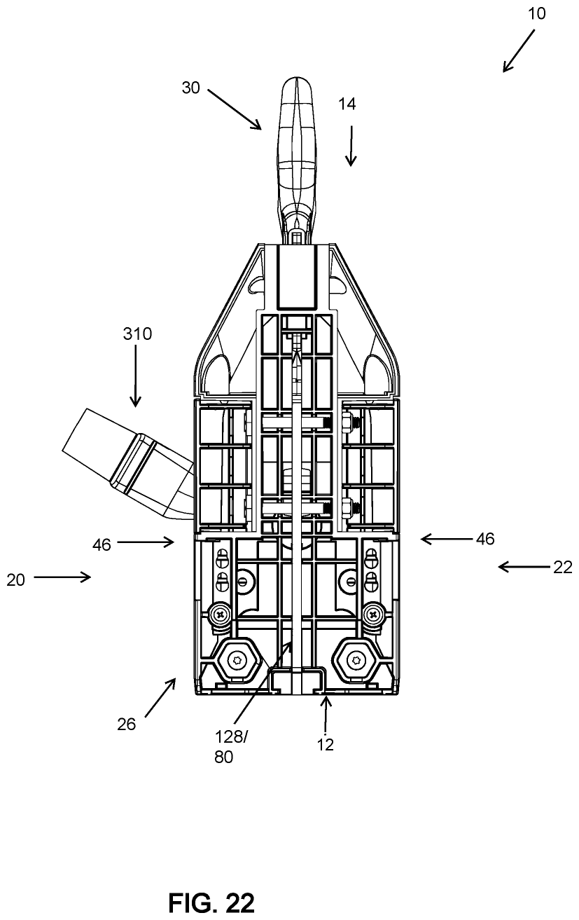

FIG. 23 shows a front view of a self-adjusting pocket hole jig system, in accordance with one or more arrangements.

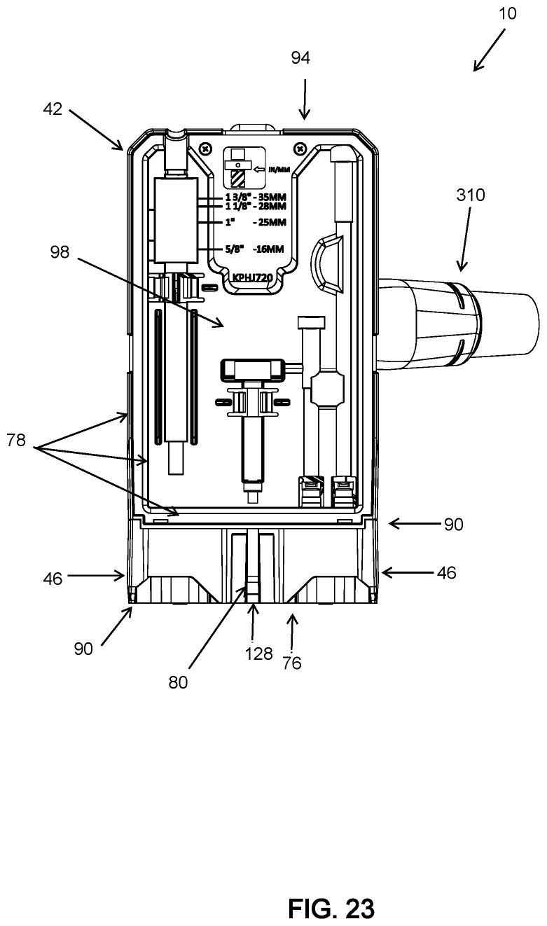

FIG. 24 shows a top view of a self-adjusting pocket hole jig system, in accordance with one or more arrangements; the view showing the clamp and drill guide assembly in a raised position, the view showing a handle in a non-clamping position.

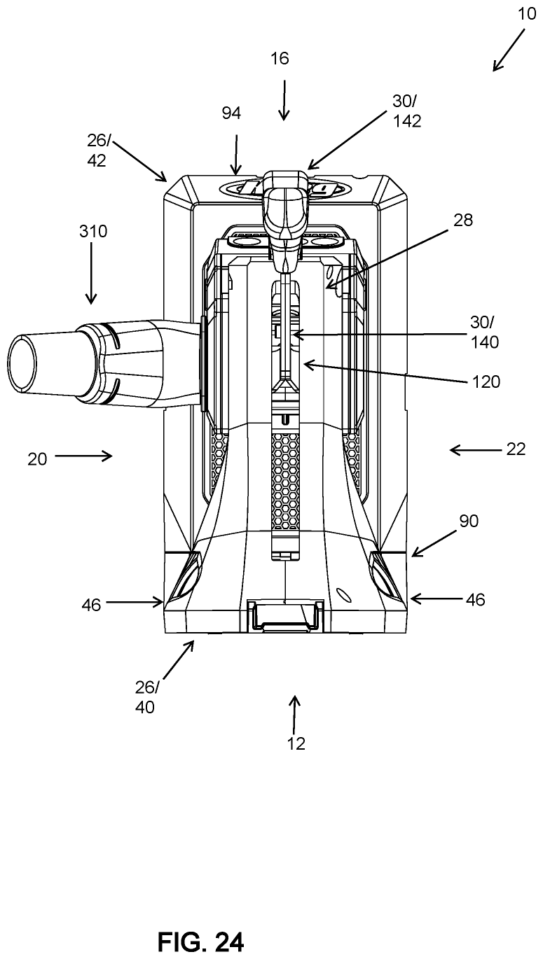

FIG. 25 shows an exploded lower rear right perspective view of a self-adjusting pocket hole jig system, in accordance with one or more arrangements.

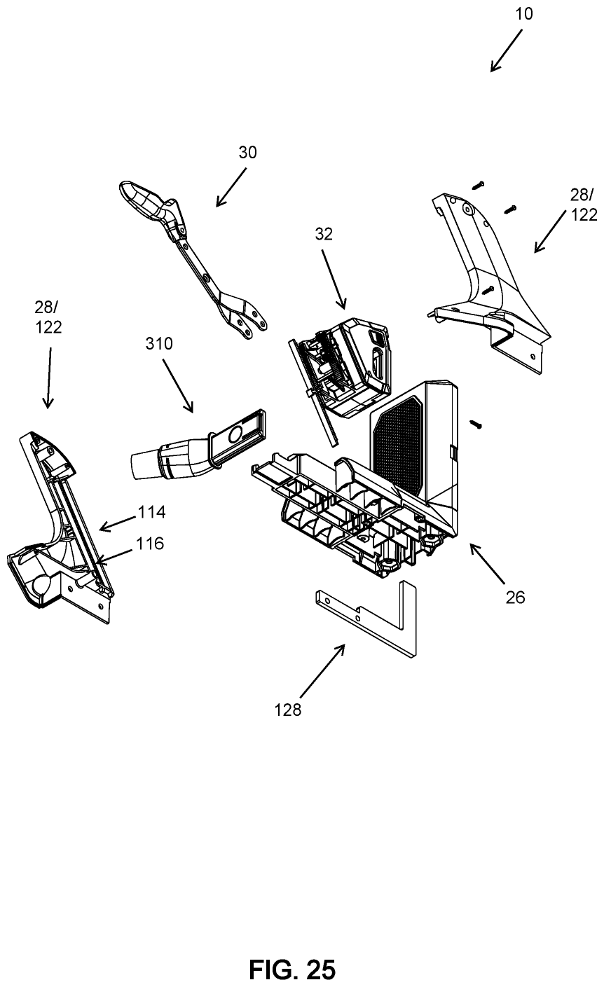

FIG. 26 shows an exploded upper rear right perspective view of a self-adjusting pocket hole jig system, in accordance with one or more arrangements.

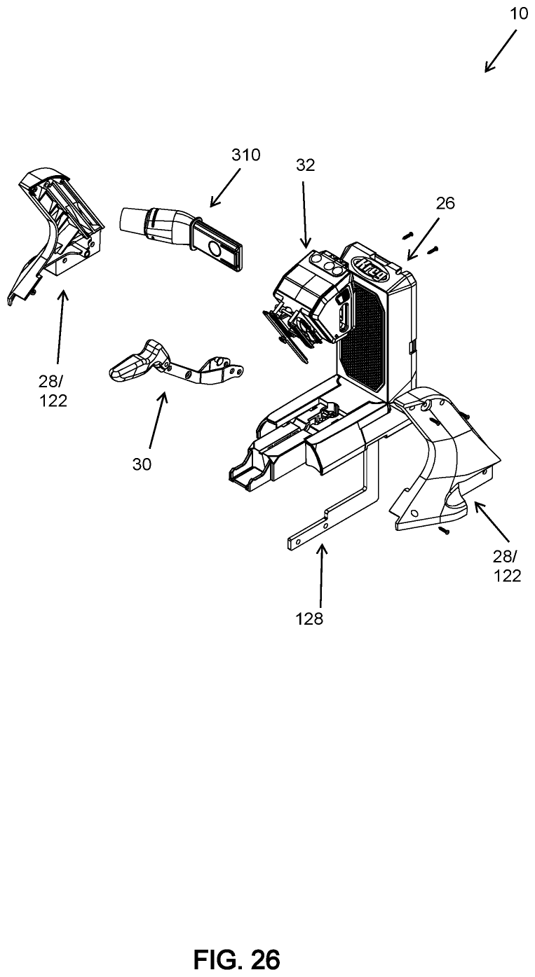

FIG. 27 shows an exploded upper front right perspective view of a self-adjusting pocket hole jig system, in accordance with one or more arrangements.

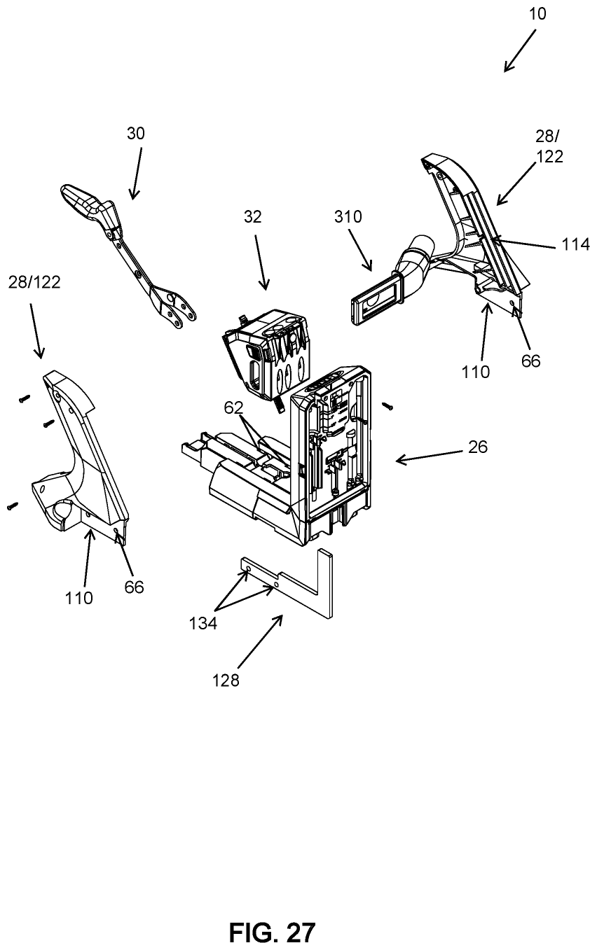

FIG. 28 shows an upper rear left perspective view of a clamp and drill guide assembly of a self-adjusting pocket hole jig system, in accordance with one or more arrangements.

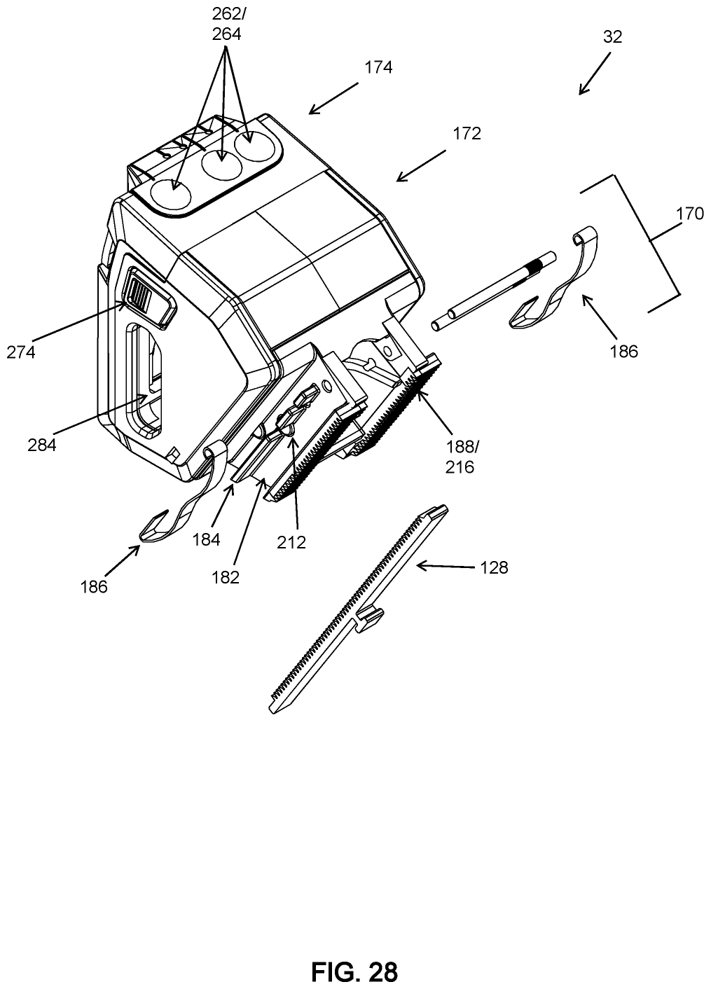

FIG. 29 shows an upper rear left perspective view of a clamp and drill guide assembly of a self-adjusting pocket hole jig system, in accordance with one or more arrangements.

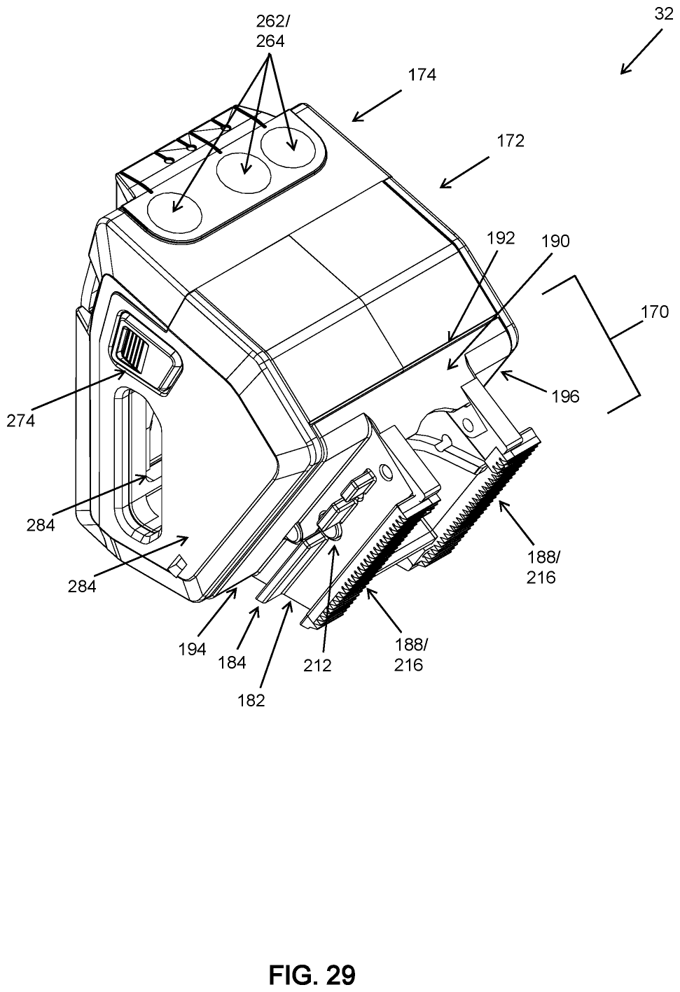

FIG. 30 shows a lower rear left perspective view of a clamp and drill guide assembly of a self-adjusting pocket hole jig system, in accordance with one or more arrangements.

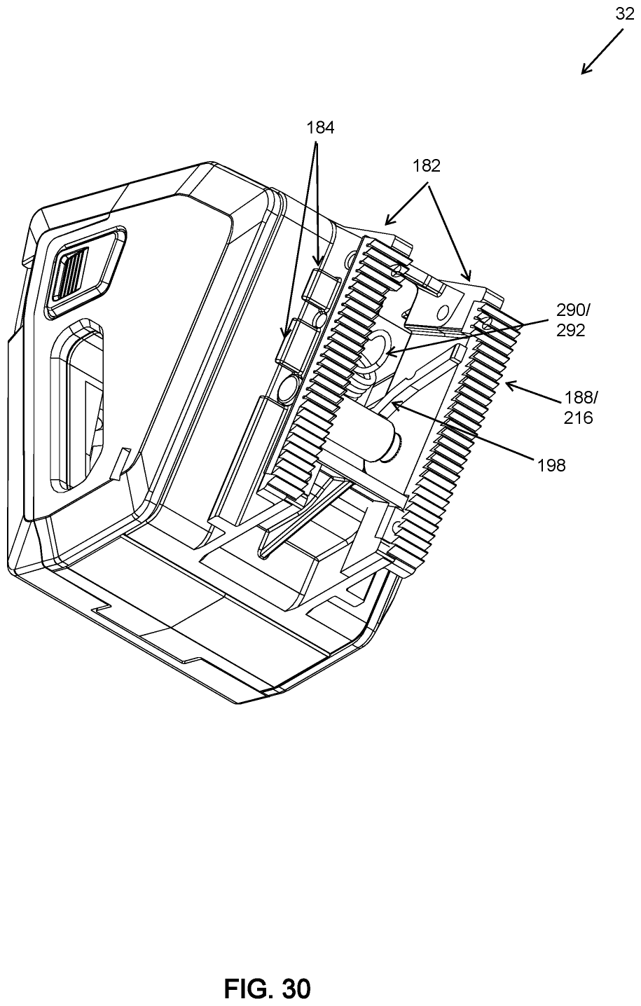

FIG. 31 shows an exploded upper front left perspective view of a clamp and drill guide assembly of a self-adjusting pocket hole jig system, in accordance with one or more arrangements.

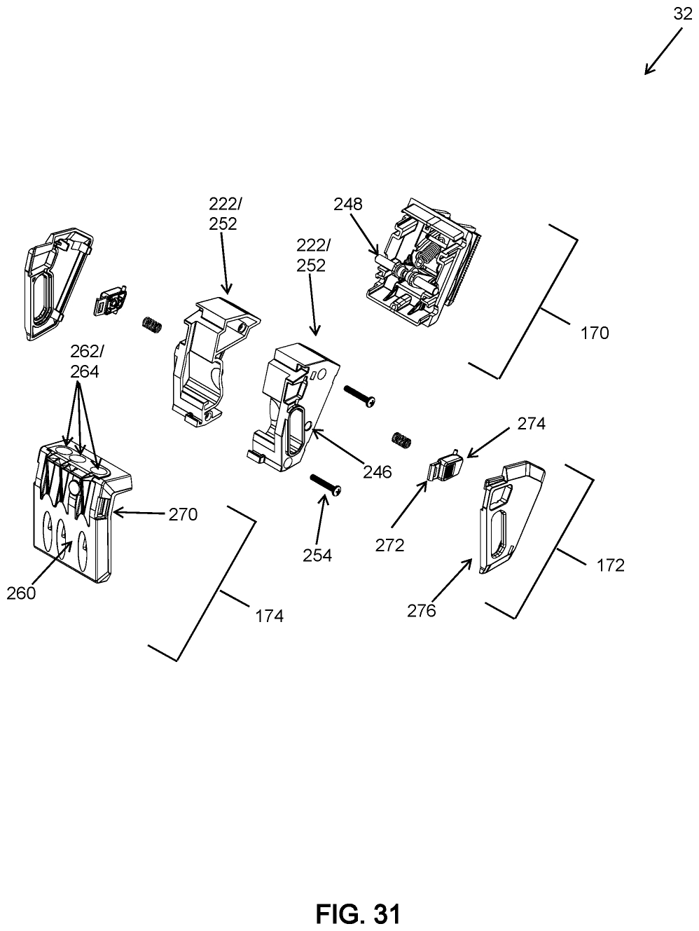

FIG. 32 shows an exploded upper front right perspective view of a clamp and drill guide assembly of a self-adjusting pocket hole jig system, in accordance with one or more arrangements.

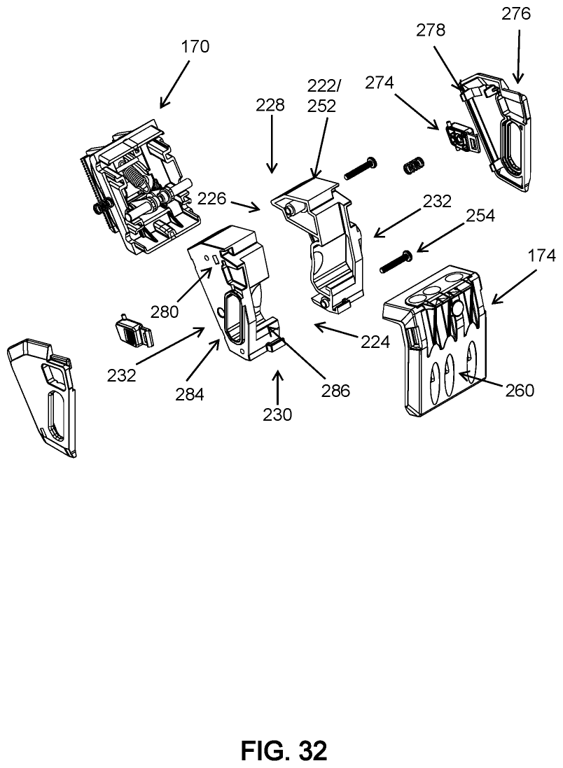

FIG. 33 shows an exploded upper front left perspective view of a clamp assembly of a clamp and drill guide assembly of a self-adjusting pocket hole jig system, in accordance with one or more arrangements.

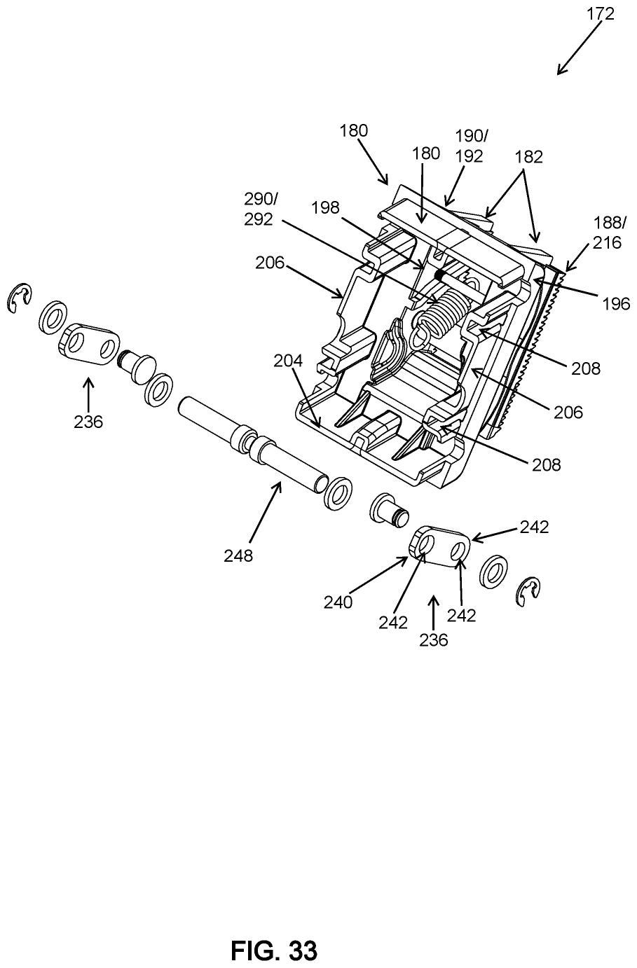

FIG. 34 shows a front view of a clamp assembly of a clamp and drill guide assembly of a self-adjusting pocket hole jig system, in accordance with one or more arrangements.

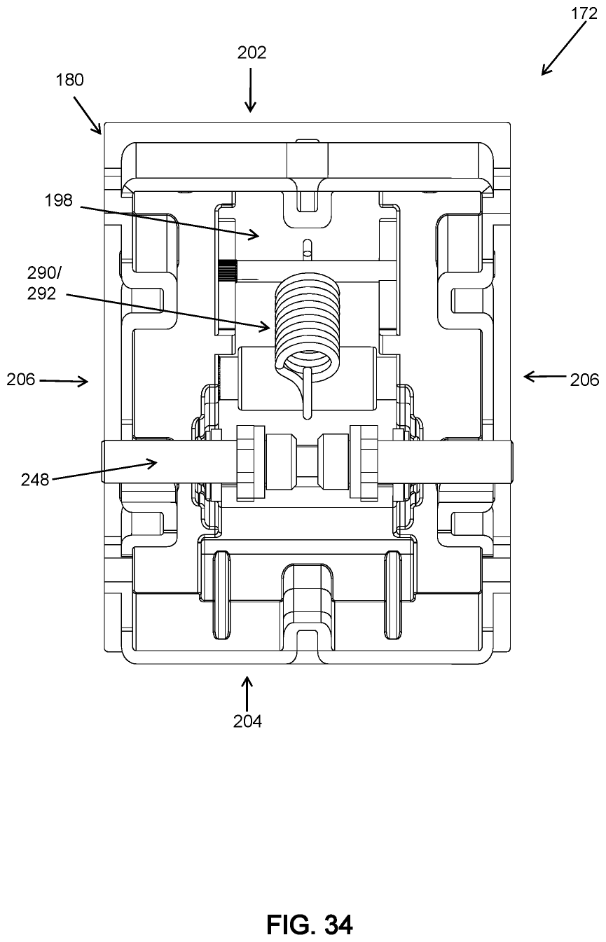

FIG. 35 shows an upper front right perspective view of a clamp assembly of a clamp and drill guide assembly of a self-adjusting pocket hole jig system, in accordance with one or more arrangements.

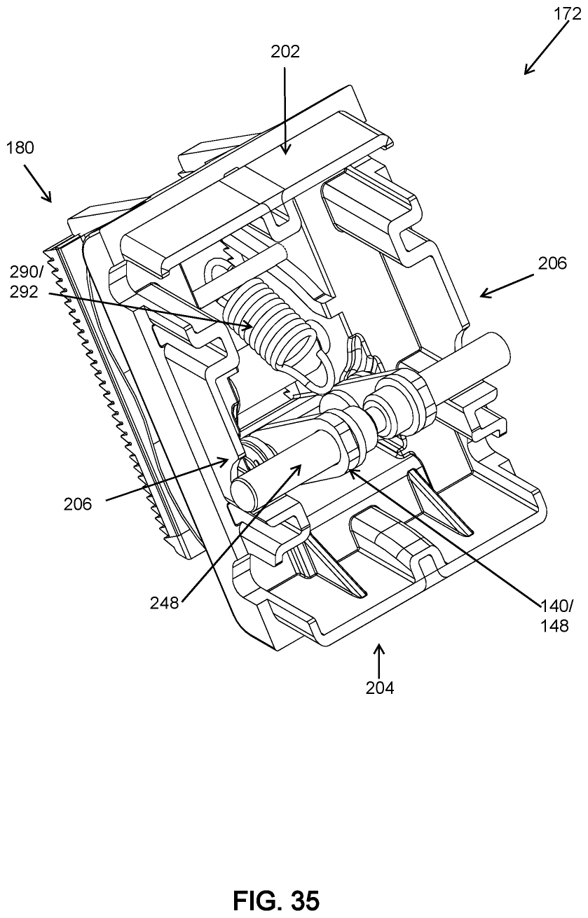

FIG. 36 shows an upper front right perspective view of a rachet strip for an upright assembly of a self-adjusting pocket hole jig system, in accordance with one or more arrangements.

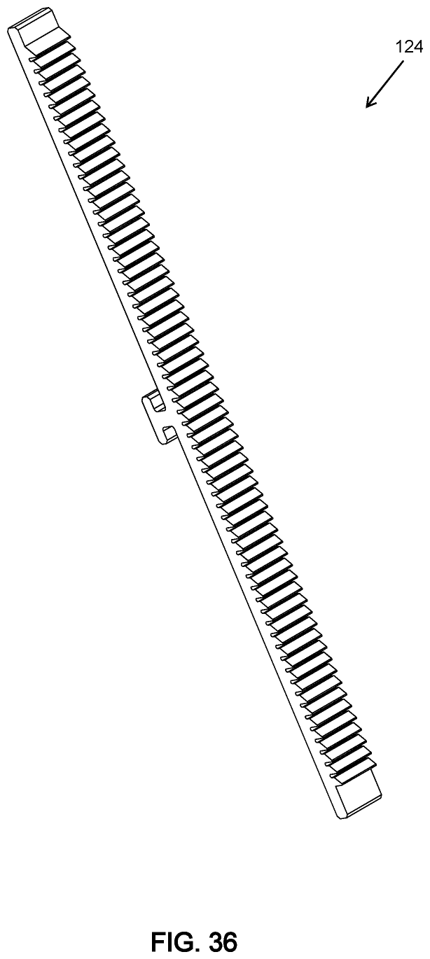

FIG. 37 shows a right side view of the rachet strip shown in FIG. 36, in accordance with one or more arrangements.

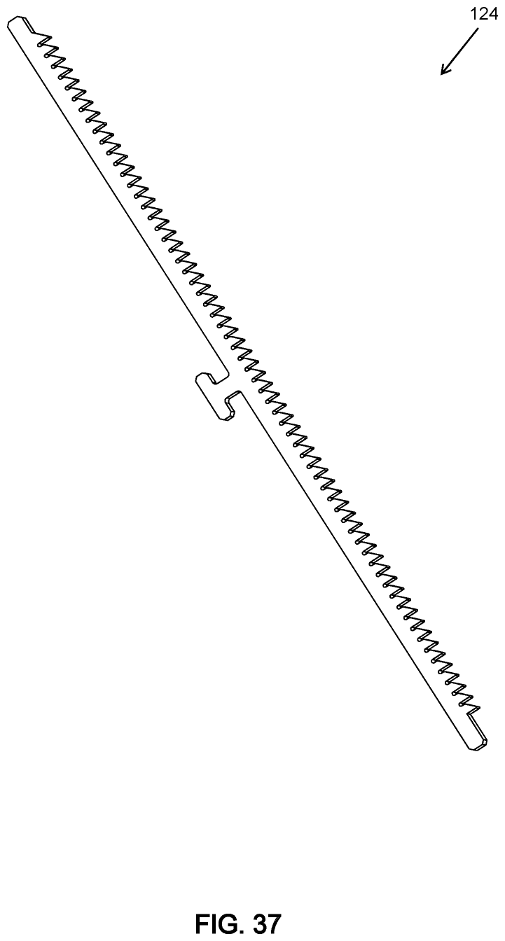

FIG. 38 shows an upper rear left perspective view of a bias member of a carrier of a clamp and drill guide assembly of a self-adjusting pocket hole jig system, in accordance with one or more arrangements.

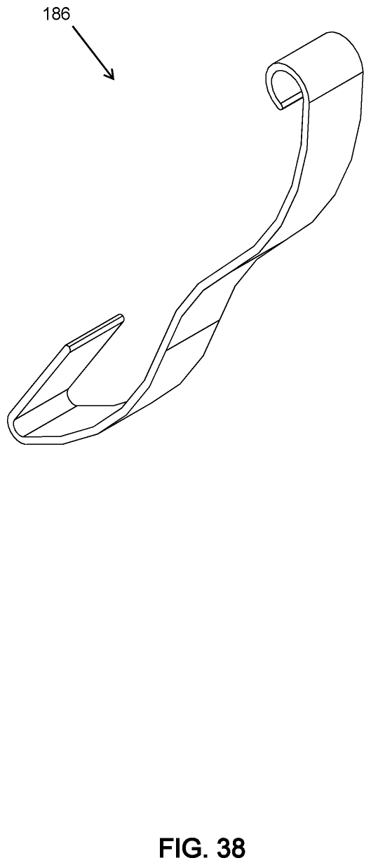

FIG. 39 shows a perspective view of a vacuum attachment for a self-adjusting pocket hole jig system, in accordance with one or more arrangements.

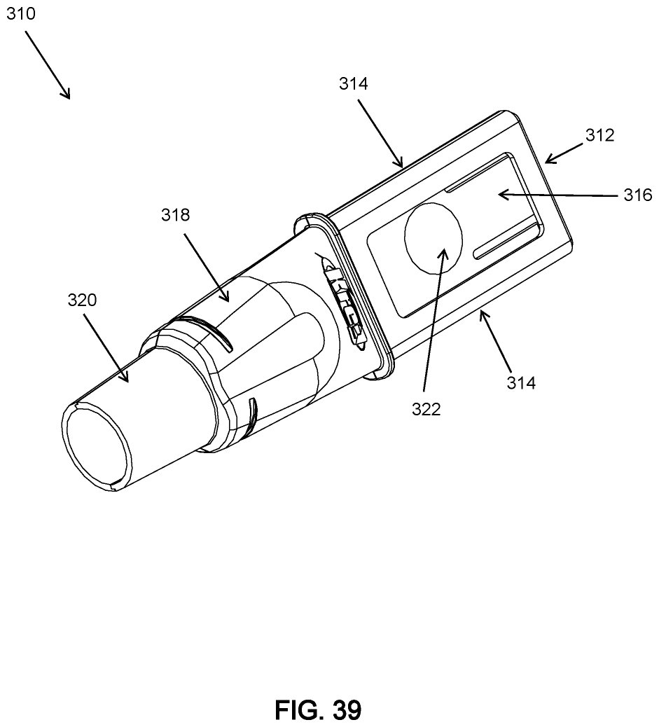

FIG. 40 shows a perspective view of a vacuum attachment for a self-adjusting pocket hole jig system, in accordance with one or more arrangements.

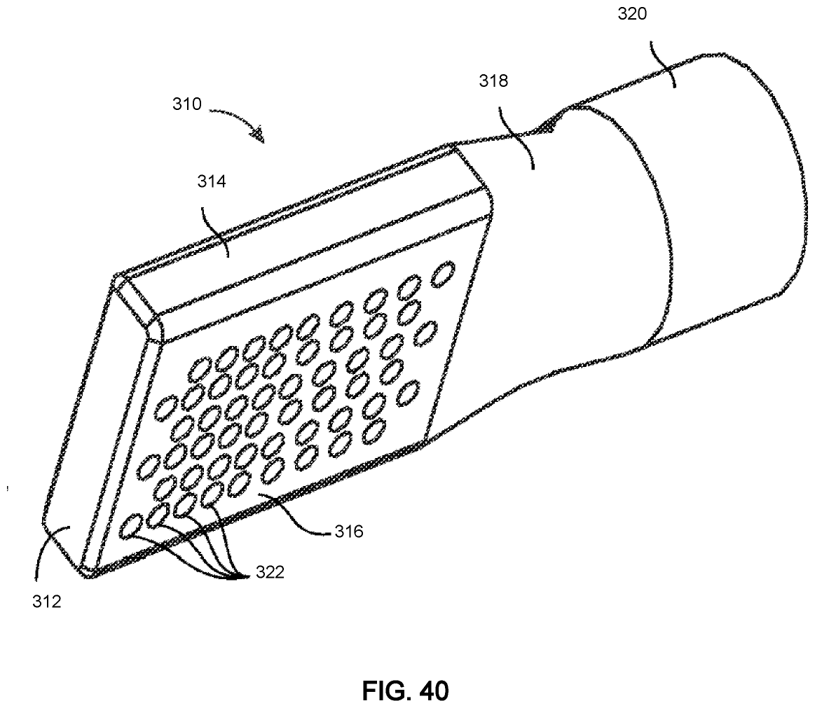

FIG. 41 shows a left side view of an actuator assembly for a self-adjusting pocket hole jig system, in accordance with one or more arrangements.

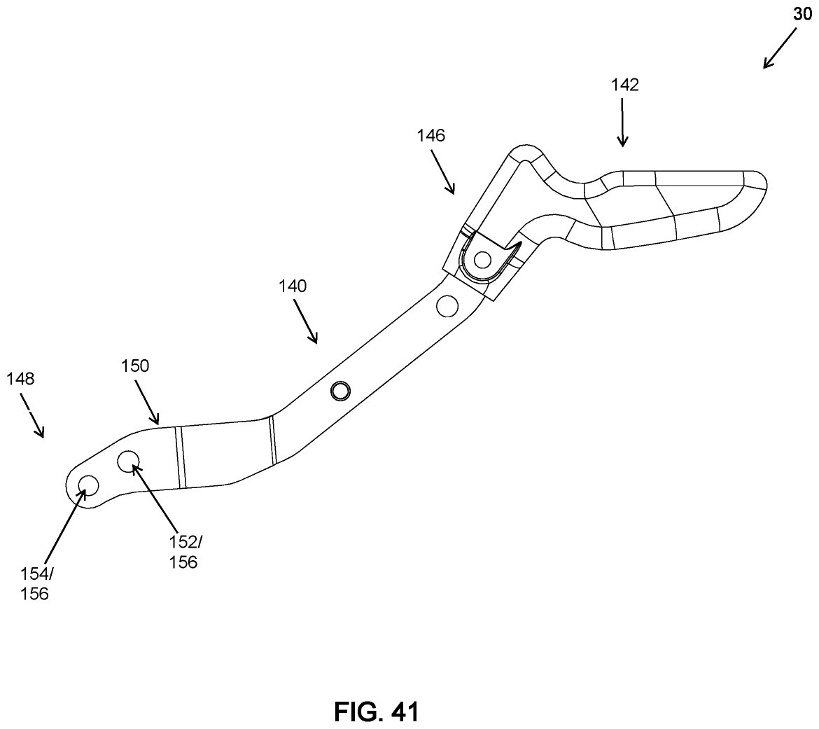

FIG. 42 shows a rear view of an actuator assembly for a self-adjusting pocket hole jig system, in accordance with one or more arrangements.

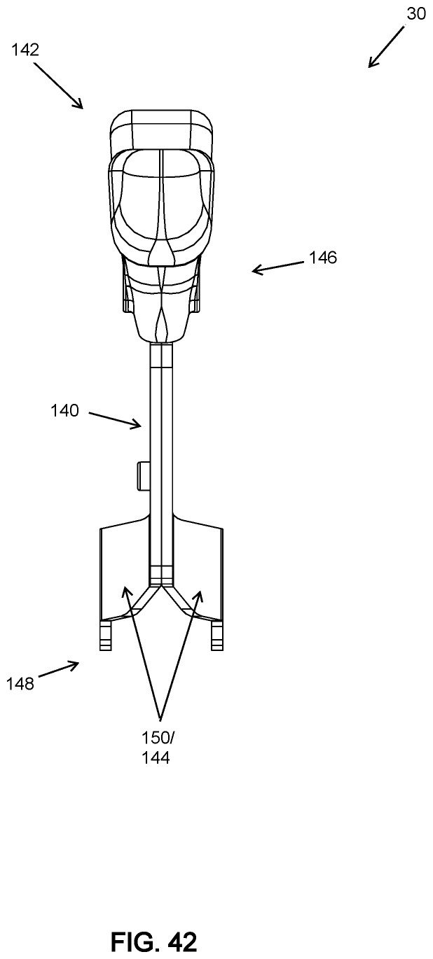

FIG. 43 shows a lower rear right perspective view of an actuator assembly for a self-adjusting pocket hole jig system, in accordance with one or more arrangements.

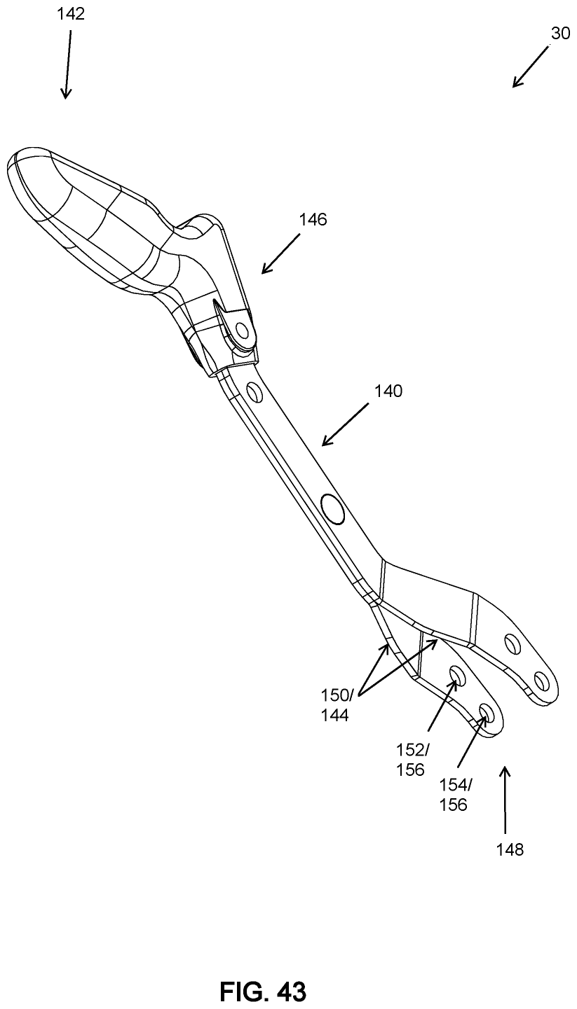

FIG. 44 shows a lower front right perspective view of an actuator assembly for a self-adjusting pocket hole jig system, in accordance with one or more arrangements.

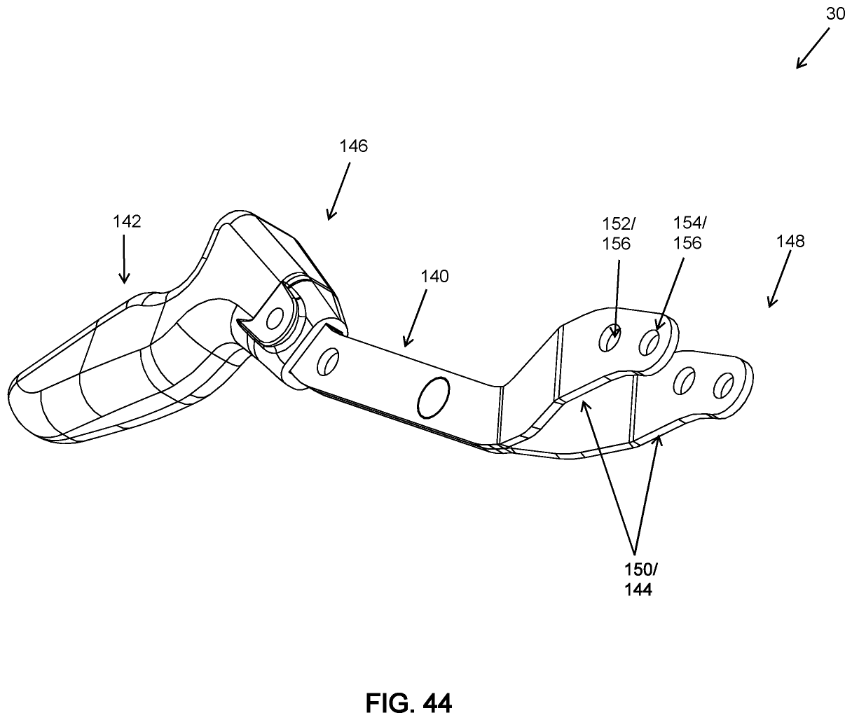

FIG. 45 shows a bottom view of an actuator assembly for a self-adjusting pocket hole jig system, in accordance with one or more arrangements.

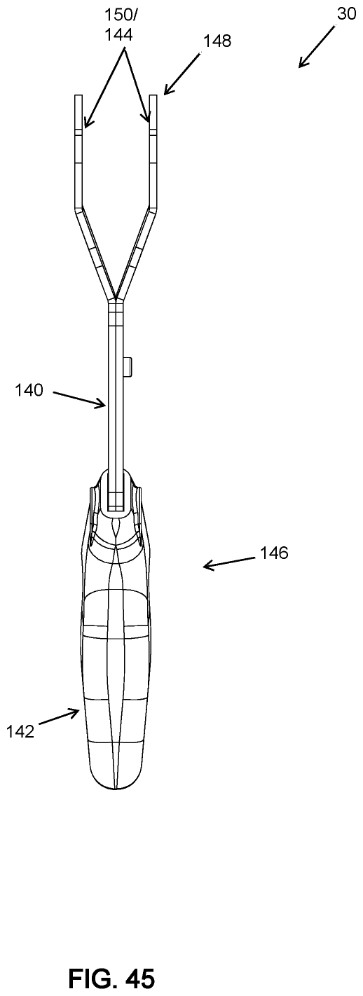

FIG. 46 shows a front view of an actuator assembly for a self-adjusting pocket hole jig system, in accordance with one or more arrangements.

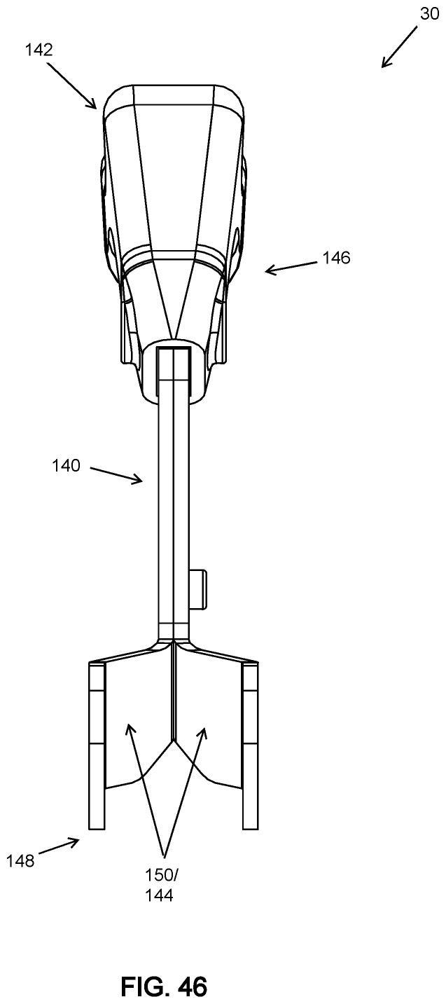

FIG. 47 shows an upper rear left perspective view of an actuator assembly for a self-adjusting pocket hole jig system, in accordance with one or more arrangements.

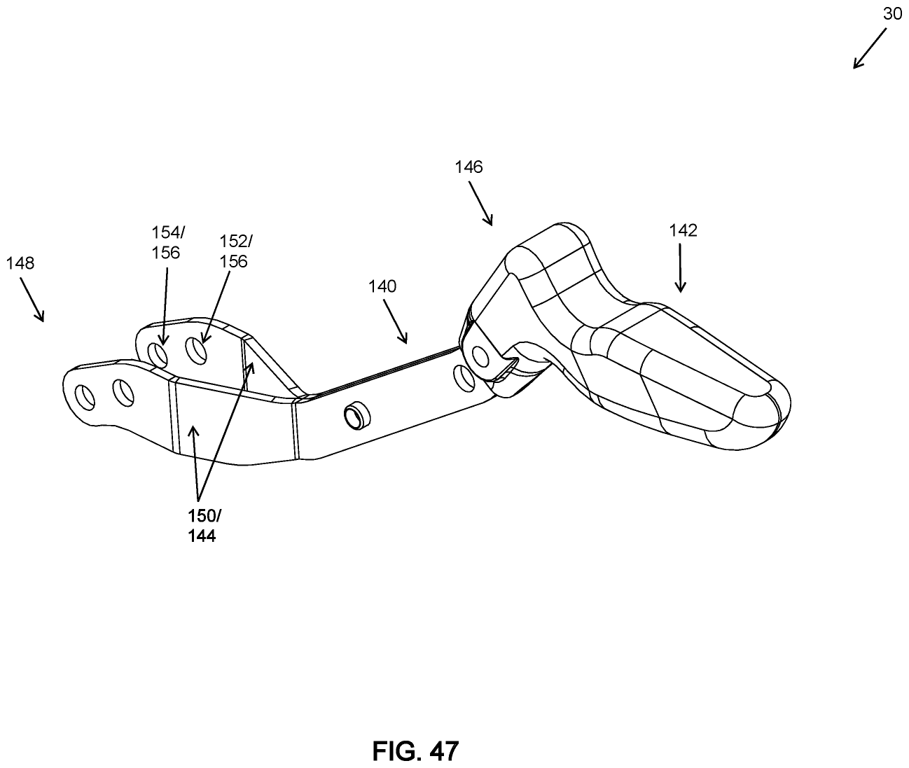

FIG. 48 shows an upper front left perspective view of an actuator assembly for a self-adjusting pocket hole jig system, in accordance with one or more arrangements.

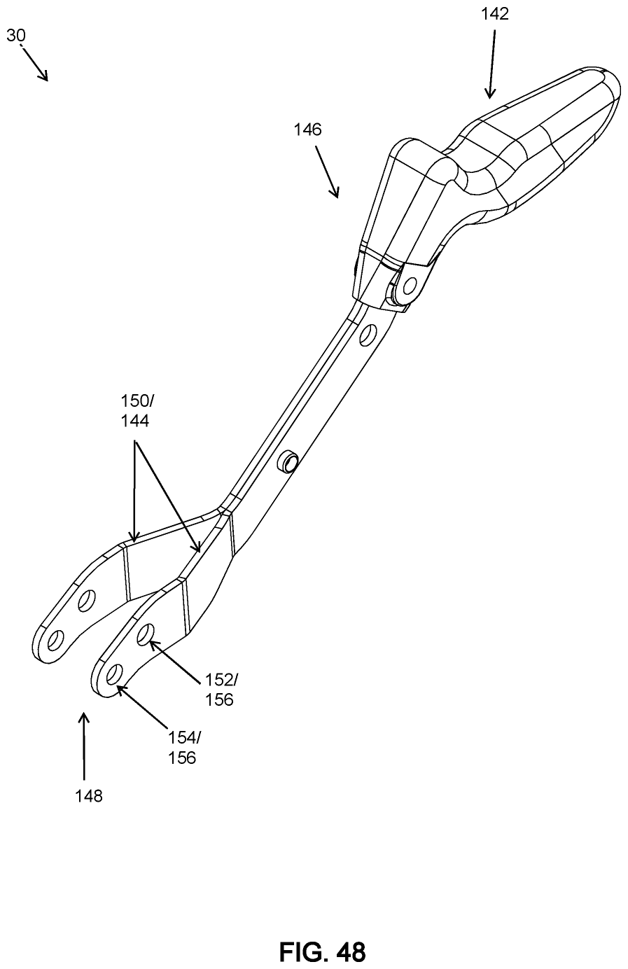

FIG. 49 shows a front view of an actuator assembly for a self-adjusting pocket hole jig system, in accordance with one or more arrangements.

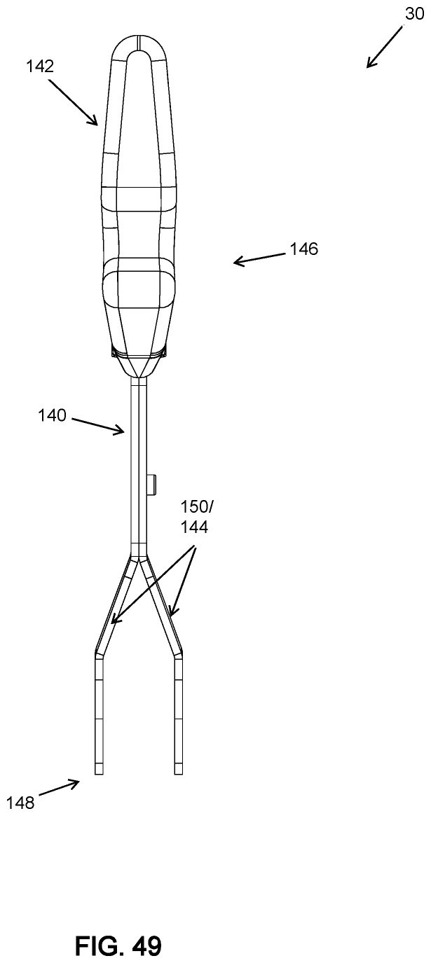

FIG. 50 shows an upper rear left perspective view of a center support for a self-adjusting pocket hole jig system, in accordance with one or more arrangements.

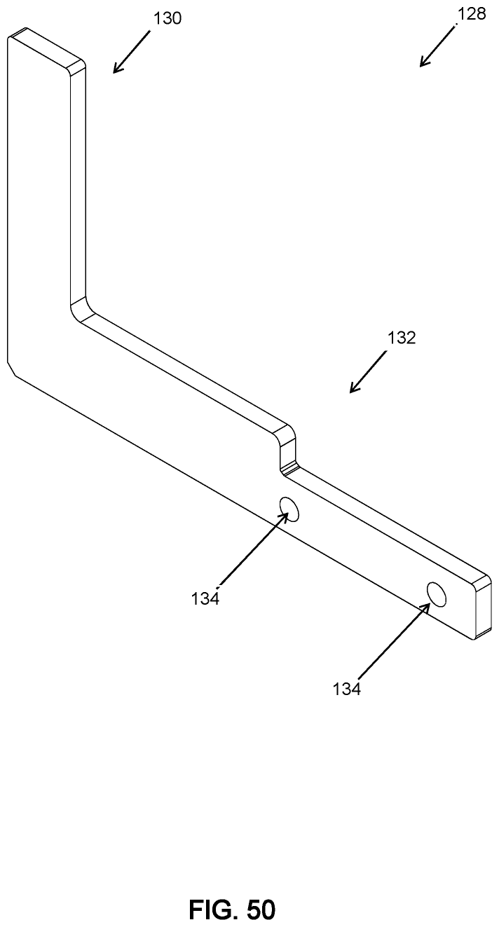

FIG. 51 shows a left side view of a center support for a self-adjusting pocket hole jig system, in accordance with one or more arrangements.

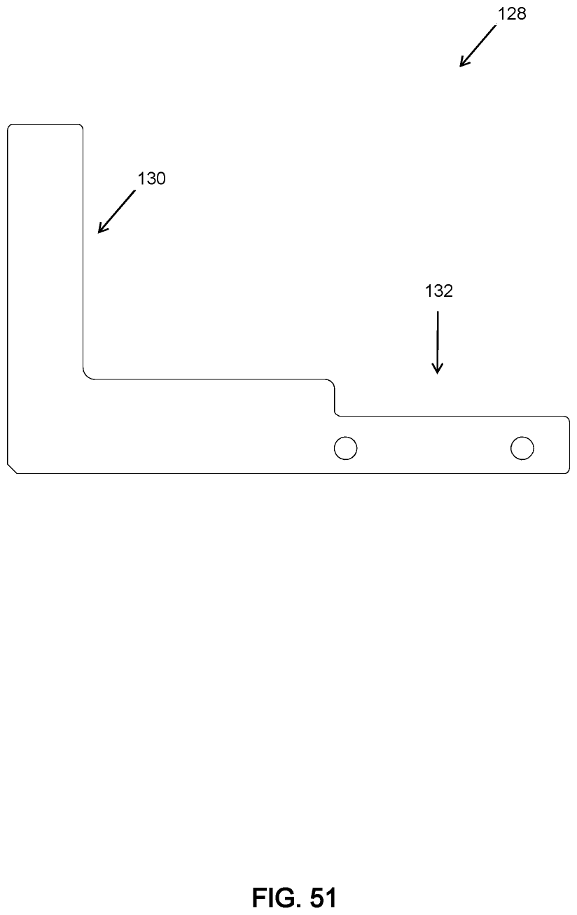

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of drilling pocket holes. However, the embodiments are not so limited. It is appreciated that the embodiments may be adapted for use in other applications which may be improved by the disclosed structures, arrangements and/or methods. The system is merely shown and described as being used in the context of drilling pocket holes for ease of description and as one of countless examples.

### System 10:

In the arrangement shown, as one example, a self-adjusting pocket hole jig system 10 (or simply “system 10”) is presented. In the arrangement shown, as one example, self-adjusting pocket hole jig system 10 has a forward side 12, a rearward side 14, a top side 16, a bottom side 18, a left side 20 and a right side 22.

Self-adjusting pocket hole jig system 10 is formed of any suitable size, shape, and design and is configured facilitate quick and easy and secure clamping of workpieces 24 of various thickness as well as various sizes and shapes. In one or more arrangements, as is shown, system 10 includes a base 26, an upright assembly 28, an actuator assembly 30, and a clamp and drill guide assembly 32, among other components.

### Workpiece 24:

In the arrangement shown, as one example, self-adjusting pocket hole jig system 10 is used to form pocket holes in a workpiece 24. Workpiece 24 may be formed of any size, shape, and design. In the arrangement shown, as one example, workpiece 24 is a generally planar shaped piece of material that may be formed of wood, plywood, composite wood, plastic, MFD (medium density fiberboard) or any other material. Workpiece 24 may be a solid piece of wood, or it may be a composite piece of wood or other material. Workpiece 24 may be a large planar member, such as a four-by-eight sheet of plywood, or it may be a narrow and small member such as a piece of face-frame, or workpiece 24 may be anything in-between. Workpiece 24 may be thick, such as one and a half inches thick, such as a two-by-four, or thicker, or it may be as narrow as half an inch, or thinner. Essentially workpiece 24 may be formed of any size, shape, and design and configuration.

### Base 26:

In the arrangement shown, as one example, self-adjusting pocket hole jig system 10 includes a base 26. Base 26 may be formed of any size, shape, and design and is configured to operably connect with upright assembly 28, actuator assembly 30, and clamp and drill guide assembly 32 to facilitate clamping of a workpiece 24 for drilling of pocket holes therein.

In the arrangement shown, as one example, base 26 when viewed from the side is formed of a generally L-shaped member having lower portion 40 and a backstop 42 that are joined together and extend in approximate perpendicular alignment to one another. In the arrangement shown, as one example, lower portion 40 and backstop 42 have generally planar opposing sides 46 that extend in approximate parallel spaced relation to one another.

In the arrangement shown, as one example, lower portion 40 includes a rearward end 48 that is generally flat and planar in shape. In the arrangement shown, as one example, the plane formed by rearward end 48 extends in approximate perpendicular alignment to the planes of sides 46 of base 26. In the arrangement shown, as one example, the outward ends of rearward end 48 connect to the rearward end of sides 46.

In the arrangement shown, as one example, lower portion 40 includes an upper surface 52. In this example arrangement, upper surface 52 forms a generally flat and planar surface extending between sides 46 from rearward end 48 to a forward end 50 of lower portion 40. In the arrangement shown, a forward portion 56 of upper surface 52 proximate to forward end 50 is configured to engage and support an end of a workpiece 24 thereon when the workpiece 24 is clamped against backstop 42. To facilitate support of workpiece 24, forward portion 56 forms a generally flat and planar surface that is approximate perpendicular alignment to the planes formed by sides 46.

In the arrangement shown, as one example, rearward portion 58 of lower portion 40 of base 26 includes one or more connection features configured to facilitate operable connection with upright assembly 28. In the arrangement shown, as one example, one or more slots 62 are generally centrally positioned within lower portion 40 when viewed from above or below and extends the majority of the distance between rearward end 48 and step 54. Slot(s) 62 are configured to receive and hold the lower end 110 of upright assembly 28 therein so as to facilitate secure attachment of upright assembly 28 to base 26. In the arrangement shown, as one example, once the lower ends 110 of halves 122 are inserted into slots 62, the lower end 110 of upright assembly 28 is screwed or bolted to the lower portion 40 of base 26 using one or more fasteners that extend laterally through holes 66 of base 26 and lower end 110 of upright assembly 28 held within slot 62, thereby securely attaching the lower end 110 of upright assembly 28 to lower portion 40 of base 26.

In one or more arrangements, lower end 110 of upright assembly 28 is additionally connected to lower arm 132 of center support 128 that is positioned in a slot 80 in the lower side 76 of base. In the arrangement shown, as one example, lower arm 132 of center support 128 includes holes 134 to facilitate such connection, for example, using one or more fasteners that extend laterally through holes 66 of base 26, lower ends 110 of halves 122 of upright assembly 28 and holes 134 of lower arm 132 of center support 128.

In the arrangement shown, as one example, the lower side 76 of lower portion 40 forms a generally flat and planar surface that is configured to facilitate stable support when the lower side 76 of self-adjusting pocket hole jig system 10 is placed on a flat work surface to be used in a vertical manner. In the arrangement shown, as one example, the generally flat planar surface of lower side 76 of lower portion 40 is formed by a lower end of a plurality of structural supports 78 that extend across and throughout the base 26, including lower portion 40 as well as backstop 42. In the arrangement shown, as one example, the plane formed by lower side 76 extends in approximate parallel spaced relationship to the planes of upper surface 52 and rearward portion 58. In the arrangement shown, as one example, the plane formed by lower side 76 extends in approximate perpendicular alignment to the plane formed by sides 46 as well as the plane formed by rearward end 48.

In the arrangement shown, as one example, the forward end of lower portion 40 connects to a lower end 90 of backstop 42. In the arrangement shown, as one example, backstop 42 includes a clamping surface 92 that is has a generally rectangular planar shape extending between sides 46 from lower end 90 to an upper end 94 of backstop 42. In the arrangement shown, as one example, clamping surface 92 faces rearward. In the arrangement shown, as one example, clamping surface 92 is configured to engage and support a forward side of a workpiece 24 when the workpiece 24 is clamped against backstop 42. To facilitate support of workpiece 24, clamping surface 92 forms a generally flat and planar rearward facing surface of backstop 42 at the forward end of upper surface 52. In the arrangement shown, as one example, the plane formed by clamping surface 92 extends in approximate perpendicular alignment to the planes of sides 46 of base 26 as well as to the plane formed by upper surface 52 of lower portion 40.

In the arrangement shown, as one example, upper end 94 of backstop 42 is generally flat and planar in shape. In the arrangement shown, as one example, the plane formed by upper end 94 extends in approximate perpendicular alignment to the planes of sides 46 of base 26 as well as clamping surface 92. In the arrangement shown, as one example, the outward ends of upper end 94 connect to the upper ends of sides 46.

In the arrangement shown, as one example, the forward side 98 of backstop 42 forms a generally flat and planar surface that is configured to facilitate stable support when the forward side 98 of backstop 42 of self-adjusting pocket hole jig system 10 is placed on a flat work surface to be used in a horizontal manner. In the arrangement shown, as one example, the generally flat planar surface of forward side 98 of lower portion 40 is formed by a forward end of a plurality of structural supports 78 that extend across and throughout the base 26, including lower portion 40 as well as backstop 42. In the arrangement shown, as one example, the plane formed by forward side 98 of backstop 42 extends in approximate parallel spaced relationship to the plane formed by clamping surface 92. In the arrangement shown, as one example, the plane formed by forward side 98 of backstop 42 extends in approximate perpendicular alignment to the plane formed by sides 46 as well as the plane formed by upper end 94.

In this way, the configuration of base 26 facilitates stable placement of and use of self-adjusting pocket hole jig system 10 in a vertical manner, when resting on lower side 76. In this way, the configuration of base 26 facilitates stable placement of and use of self-adjusting pocket hole jig system 10 in a horizontal manner, when resting on forward side 98.

In the arrangement shown, as one example, the distance between lower side 76 and upper surface 52 is approximately the thickness of a conventional two-by-four. Similarly, in the arrangement shown, as one example, the distance between forward side 98 and clamping surface 92 is approximately the thickness of a conventional two-by-four. As such, a conventional two-by-four can be used to make jigs or other support members when using self-adjusting pocket hole jig system 10 to drill pocket hole jigs regardless of whether the self-adjusting pocket hole jig system 10 is used in a vertical orientation or a horizontal orientation.

In the arrangement shown, as one example, base 26 is a formed of a single monolithic member that is formed by any process such as molding, injection molding, casting, forming, machining, or through any other manufacturing process. In one or more arrangements, base 26 is formed of a solid member. In one or more arrangements, one or more portions of base 26, may be formed of a hollow skeletonized structure with structural supports so as to provide the requisite strength while minimizing weight and material usage. In the arrangement shown, as one example, base 26 is skeletonized and includes structural supports 78 that extends across the lower side 76 and forward side 98 of base 26.

Additionally or alternatively, in some other arrangements, base 26 is formed of a plurality of components that are operably connected to one another, for example, by fastening means (e.g., screws, bolts, pins, clips, etc.), clamps, press fitting, friction fitting, gluing, welding, adhering, or by any other manner, method or means or the like. In one or more arrangements, base 26 is formed of a plastic or composite material. In another arrangement, base 26 is formed of a metallic material. In another arrangement, base 26 is formed of a plastic or composite material that includes metallic support members that extend through the base 26 thereby providing additional strength and rigidity.

### Upright Assembly 28:

In one or more arrangements, self-adjusting pocket hole jig system 10 includes an upright assembly 28 connected to base 26. Upright assembly 28 may be formed of any size, shape, and design and is configured to provide support for actuator assembly 30 and clamp and drill guide assembly 32 to facilitate clamping of workpiece 24 in self-adjusting pocket hole jig system 10.

In the arrangement shown, as one example, upright assembly 28 has a contoured rectangular shape having a front 104, a rear 106, and opposing sides 108 extending from a lower end 110, where upright assembly 28 connects with lower portion 40 of base 26, to an upper end 112.

In the arrangement shown, as one example, upright assembly 28 has a track 114 extending along front 104. Track 114 is formed of any suitable size, shape, and design and is configured to operably connect with and guide movement of clamp and drill guide assembly 32. In the arrangement shown, as one example, track 114 is formed pair of opposing channels 116 extending along opening 120 in inward sides of the opposing sides 108 of upright assembly 28. In this example arrangement, track guides 184 of a carrier 170 of clamp and drill guide assembly 32 are configured to engage and slide along channels 116 during operation to guide carrier 170 along track 114 of upright assembly 28. However, the arrangements are not so limited. Rather, it is contemplated that in some various arrangements, track 114 may additionally or alternatively utilize various other different methods and/or means to guide movement of clamp and drill guide assembly 32.

In the arrangement shown, upright assembly 28 includes an opening 120 extending through a center portion of upright assembly 28 from front 104 to rear 106. In this example arrangement, opening 120 permits actuator assembly 30 to extend through opening 120 and connect with clamp and drill guide assembly 32 and also permits actuator assembly 30 to be moved upward and downward by a user to facilitate clamping of a workpiece 24 using system 10.

In one or more arrangements, as is shown, upright assembly 28 is formed by a pair of symmetric halves 122, each form one of the respective sides 108, which are joined together (e.g., by fasteners). However, the arrangements are not so limited. Rather it is contemplated that sides 108 and/or other components forming upright assembly 28 may be connected to one another by any manner, method or means including but not limited to, for example fasteners (e.g., screws, bolts, pins, clips, etc.), clamps, press fitting, friction fitting, gluing, welding, adhering, or by any other manner, method or means or the like. Additionally or alternatively, in some arrangements, upright assembly 28 may be formed as a unitary body.

### Ratchet Strips 124:

In one or more arrangements, upright assembly 28 includes one or more ratchet strips 124. Ratchet strips 124 are formed of any suitable size, shape, and design and are configured to engage a ratchet mechanism 188 of clamp and drill guide assembly 32 to facilitate holding of clamp and drill guide assembly 32 in position along track 114 when clamping of a workpiece 24 against clamping surface 92 of backstop 42 of base 26. In the arrangement shown, as one example, ratchet strips 124 have teeth arranged along elongated strips with the teeth sloped downward to facilitate easier ratcheting of clamp and drill guide assembly 32 downward along track 114 when clamping workpiece 24. However, the arrangements are not so limited. Rather, it is contemplated that some various arrangements may utilize various additional or alternative methods and/or means to hold clamp and drill guide assembly 32 in position along track 114 when clamping of a workpiece 24. As one alternative example, in some arrangements, upright assembly 28 may include a ratcheting mechanism configured to engage ratchet strips of clamp and drill guide assembly 32 as drill guide assembly 32 is moved along track 114.

### Center Support 128:

In the arrangement shown, as one example, system 10 includes a center support 128. Center support 128 is itself formed of any suitable size, shape, and design and is configured to operably connect to lower portion 40 of base 26 and backstop 42 of base 26 and to provide support for upright assembly 28. In the arrangement shown, as one example, center support 128 is formed of generally planar member L-shaped member having an upper arm 130 configured to operably connect with backstop 42 and a lower arm 132 configured to operably connect with lower portion 40 of base 26 and lower end 110 of upright assembly 28.

In the arrangement shown, as one example, upper arm 130 is configured to be received and held within a slot 96 of backstop 42 extending upward from an underside of the backstop 42. In this example arrangement, lower arm 132 is configured to be received and held within a central slot 96 of backstop 42 extending upward from an underside of the backstop 42. In one or more arrangements, lower end 110 of upright assembly 28 is operably connected to lower arm 132 of center support 128 to provide secure support and connection between backstop 42 of base 26 and upright assembly 28 for clamping of workpieces 24. In the arrangement shown, as one example, lower arm 132 of center support 128 includes holes 134 to facilitate such connection, for example, using one or more fasteners that extend laterally through holes 66 of base 26, lower ends 110 of halves 122 of upright assembly 28 and holes 134 of lower arm 132 of center support 128.

However, the arrangements are not so limited. Rather, it is contemplated that in some various arrangements, center support 128 may be operably connected with upright assembly 28, base 26, and/or other components of system 10 using various means, methods, and techniques known in the art including but not limited to, for example, adhesive bonding, chemical bonding, welding, and/or mechanical attachments means such as screws, bolts, threading, interlocks, latches, clips, pins, or other coupling devices.

In one or more arrangements, center support 128 is formed of a solid metallic material, so as to maximize strength and rigidity and durability as well as to provide a long useful life. However, other size shape or design as well as any other material is hereby contemplated for use for center support 128.

### Actuator Assembly 30:

Actuator Assembly 30 is formed of any suitable size, shape, and design, and is configured to facilitate movement of clamp and drill guide assembly 32 along track 114 of upright assembly 28 and clamping of a workpiece 24. In the arrangement shown, as one example, actuator assembly 30 is formed of a lever 140 and a handle 142, among other components.

### Lever 140:

Lever 140 is formed of any suitable size, shape, and design and is configured to operably connect with clamp and drill guide assembly 32 and facilitate controlled movement of clamp and drill guide assembly 32 along track 114 and clamping. In this example arrangement, lever 140 is generally straight. However, embodiments are not so limited. Rather, it is contemplated that lever 140 may be straight, curved, angled, meandering, or be any other shape.

In the arrangement shown, as one example, lever 140 is formed by a pair of elongated generally planar shaped bars 144 fastened together and extending from an upper end 146 of lever 140, which is operably connected to a handle 142, to a lower end 148 of lever 140, which operably connected to clamp and drill guide assembly 32. In this example arrangement, bars 144 of lever 140 fork proximate to the lower end 148 into a pair of arms 150, which connect with clamp and drill guide assembly 32.

In some various different arrangements, lower end 148 of lever 140 may be operably connected to clamp and drill guide assembly 32 using various different attachment means or methods. In the arrangement shown, as one example, arms 150 of lever 140 have an upper pivotal connection 152 and a lower pivotal connection 154 with clamp and drill guide assembly 32. In this example arrangement, the upper pivotal connection 152, operates to move clamp and drill guide assembly 32 along track 114 and also operates as a fulcrum as lever 140 is rotated downward. In this example arrangement, lower pivotal connection 154 is operably connected with a clamp assembly 172 of clamp and drill guide assembly 32 and operates to move a drill guide block 174 and clamping face 260 thereof forward when an upper end 112 of lever 140 is rotated rearward and downward.

In the arrangement shown, as one example, upper pivotal connection 152 and lower pivotal connection 154 each include holes 156 in arms 150 and a fastener 158 extending through holes 156. However, embodiments are not so limited. Rather, it is contemplated that lower end 148 of lever 140 may be connected to clamp and drill guide assembly using various means, methods, and techniques known in the art including but not limited to, for example, adhesive bonding, chemical bonding, welding, and/or mechanical attachments means such as screws, bolts, threading, interlocks, latches, clips, pins, or other coupling devices.

### Handle 142:

Handle 142 is formed of any suitable size, shape, and design and is configured to facilitate hand-controlled movement of upper end 146 of lever 140 by a user. In the arrangement shown, as one example, handle 142 is a pistol type hand grip positioned at upper end 146.

In this example arrangement, handle 142 is oriented to facilitate a user moving lever 140 of actuator assembly 30 to move clamp and drill guide assembly 32 upward and downward along track 114 as also to facilitate rotation of the lever between clamping and non-clamping positions to facilitate locking of move clamp and drill guide assembly 32 in position along track 114 and clamping of workpieces 24. However, embodiments are not so limited. Rather, it is contemplated that handle 142 may be implemented using various different types of handgrips including but not limited to horizontal handgrips, vertical handgrips, knobs, wheels, loops, and/or any other type of handle or handgrip.

### Example Operation:

As an illustrative example, in one or more arrangements, handle 142 is oriented to facilitate rotation of the lever 140 rearward and downward from a generally upright non-clamping position to a tilted clamping position. In this example arrangement, when handle 142 is rotated to the non-clamping position, clamp and drill guide assembly 32 is permitted to move upward and downward along track 114. That is, when handle 142 is in the non-clamping position, handle 142 is oriented to facilitate a user moving lever 140 of actuator assembly 30 to move clamp and drill guide assembly 32 upward and downward along track 114 to place clamp and drill guide assembly 32 in proper position for clamping of a workpiece 24. For example, a user may place a workpiece 24 on upper surface 52 of base 26 against clamping surface 92 backstop 42 of base and lower handle in the non-clamping position to move clamp and drill guide assembly 32 downward until clamping face 260 of drill guide block 174 of clamp and drill guide assembly 32 contacts workpiece. With clamping face 260 of drill guide block 174 of clamp and drill guide assembly 32 in contact with workpiece 24, a user may rotate handle 142 downward and rearward from the non-clamping position to the clamping position. In one or more arrangements, when handle 142 is moved to the clamping position, clamp and drill guide assembly 32 becomes locked in position along track 114. In one or more arrangements, when handle 142 is moved to the clamping position, clamping face 260 of drill guide block 174 is moved forward to facilitate clamping of workpiece 24 between clamping face 260 and clamping surface 92. When drilling of a pocket hole is completed, a user may rotate handle 142 upward and forward to the non-clamping position to unclamp workpiece 24 and permit clamp and drill guide assembly 32 to move upward along track 114 to a raised position to facilitate easy removal of workpiece.

### Clamp and Drill Guide Assembly 32:

Clamp and drill guide assembly 32 is formed of any suitable size, shape, and design and is configured to facilitate clamping of a workpiece 24 against clamping surface 92 of backstop 42 and drilling of pocket holes in the workpiece 24. In the arrangement shown, as one example, clamp and drill guide assembly 32 includes a carrier 170, a clamp assembly 172, and a drill guide block 174, among other components.

### Carrier 170:

Carrier 170 is formed of any suitable size, shape, and design and is configured to operably connect with and facilitate movement along track 114 of upright assembly 28. In the arrangement shown, as one example, carrier 170 includes a main body 180, a pair of rails 182 extending along a backside of the main body 180, a set of track guides 184, and a ratchet mechanism 188, among other components.

### Main Body 180:

Main body 180 of carrier 170 is formed of any suitable size, shape, and design and is configured to interconnect various components of carrier 170 and operably connect with actuator assembly 30 and clamp assembly 172. In the arrangement shown, as one example, main body 180 has a generally rectangular back 190 extending between an upper edge 192, a lower edge 194, and opposing side edges 196. In this example arrangement, back 190 includes an opening 198 configured to facilitate connection of lever 140 of actuator assembly 30 with carrier 170 and clamp assembly 172.

In the arrangement shown, as one example, main body includes a top wall 202, a bottom wall 204, and side walls 206 extending forward from back 190. In this example arrangement, top wall 202, bottom wall 204, and/or side walls 206 include features 208 (e.g., channels, stops, etc.) to facilitate operable connection with clamp assembly 172 while permitting clamp assembly 172 to move forward and rearward relative to main body 180.

### Rails 182:

Rails 182 are formed of any suitable size, shape, and design and are configured to operably connect main body 180 with track guides 184 and lever 140 of actuator assembly 30. In the arrangement shown, as one example rails 182 have an elongated generally rectangular shape extending along a back surface of back 190 from upper edge 192 to lower edge 194. In the arrangement shown, rails 182 are configured to fit within opening 120 of upright assembly 28 alongside track 114 with close and tight tolerances to help guide carrier 170 along track 114. In the arrangement shown, rails 182 include a set of holes 212 to facilitate connection with upper pivotal connection 152 of lever 140 (e.g., by fastener 158 positioned within holes 212 and extending between rails 182.

### Track Guides 184:

Track guides 184 are formed of any suitable size, shape, and design and are configured to engage track 114 and guide carrier 170 along track 114. In the arrangement shown, as one example, track guides 184 are flanges that extend outward from the sides of rails 182 and into channels 116 of track 114. However, the arrangements are not so limited. Rather, it is contemplated that some arrangements may utilize various additional and/or alternative methods and/or means to guide carrier 170 along track 114.

In one or more arrangements, channels 116 of track 114 are wider than track guides 184 so as to permit carrier 70 of clamp and drill guide assembly 32 to move forward and backward relative to track 114. In this example arrangement, carrier 170 includes bias members 186 configured to bias track guides 184 toward forward edges of channel channels 116 in absence of an opposing force. This arrangement permits carrier 170 and clamp and drill guide assembly 32 to move rearward as may be required during operation, for example, to avoid to overstressing components and/or facilitate ratcheting when clamping of workpieces 24. In the arrangement shown, as one example, bias members 186 are leaf springs operably connected with carrier 170 and configured to engage track 114 or other surface of upright assembly 28 to bias carrier 170 and clamp and drill guide assembly 32 forward in absence of an opposing force. However, the arrangements are not so limited. Rather, it is contemplated that in some various arrangements, bias members 186 may be implemented using various methods and/or means including but not limited to, for example, springs (e.g., compression springs, leaf springs and/or other flat springs, torsion springs, extension springs, and/or air springs), compressible materials, and/or any other method and/or means of biasing.

### Ratchet Mechanism 188:

In one or more arrangements, clamp and drill guide assembly 32 includes a ratchet mechanism 188. Ratchet mechanism 188 is formed of any suitable size, shape, and design and is configured to ratchet and/or otherwise hold clamp and drill guide assembly 32 in position along track 114 when clamping of workpieces 24. In the arrangement shown, as one example, ratchet mechanism 188 includes one or more ratchet strips 216 operably connected to carrier 170. In this example arrangement, the ratchet strips 216 of ratchet mechanism 188 are operably connected to rearward edges of rails 183 of carrier 170 and are configured to engage ratchet strips 124 of upright assembly 28 when clamp and drill guide assembly 32 is moved rearward within track 114 of upright assembly 28 (e.g., when clamping of workpieces 24).

In this example arrangement, when clamp and drill guide assembly 32 is moved rearward, teeth of ratchet strips 216 of ratchet mechanism 188 engage teeth of ratchet strips 124 of upright assembly 28, which prevents clamp and drill guide assembly 32 from moving upward along track 114. In this example arrangement, teeth of ratchet strips 216 and ratchet strips 124 are sloped in complementary directions so as to more easily permit clamp and drill guide assembly 32 to be moved downward along track 114, thereby ratcheting clamp and drill guide assembly 32 into tighter engagement with a workpiece 24 to be clamped. However, the arrangements are not so limited. Rather, it is contemplated that some various arrangements may utilize various additional or alternative methods and/or means to hold clamp and drill guide assembly 32 in position along track 114 and/or facilitate ratcheting when clamping of a workpiece 24.

### Clamp Assembly 172:

In one or more arrangements, clamp and drill guide assembly 32 includes a clamp assembly 172 operably connected to carrier 170, actuator assembly 30, and drill guide block 174. Clamp assembly 172 is formed of any suitable size, shape, and design and is configured to be moved forward and rearward by actuator assembly 30 relative to carrier 170 to facilitate clamping of a workpiece 24 against clamping surface 92 of backstop 42 of base 26.

In the arrangement shown, as one example, clamp assembly 172 includes a main body 222 having a front 224, back 226, top 228, bottom 230, and opposing sides 232. In this example arrangement, back 226 is open and is configured to fit over front ends of top wall 202, bottom wall 204, and/or side walls 206 In this example arrangement, main body 222 of clamp assembly 172 has features 234 (not shown) configured to engage features 208 of main body 180 of carrier 170 to operably connect clamp assembly 172 with carrier 170 while permitting main body 222 of clamp assembly 172 to be moved forward and backward relative to carrier 170.

In one or more arrangements, clamp assembly 172 includes a link 236 connecting lower pivotal connection 154 of lever 140 of actuator assembly 30 to main body 222 of clamp assembly 172. In the arrangement shown, as one example, link 236 has an elongated generally rectangular planar shape extending between a forward end 238 and a rearward end 240. In this example arrangement, link 236 has holes 242 to facilitate connection with lower pivotal connection 154 of lever 140 and main body 222 of clamp assembly 172 (e.g., by fasteners extending through holes 242). In the arrangement shown, sides 232 of main body 222 of clamp assembly 172 include a set of holes 246 to facilitate connection with forward end 239 of link 236 (e.g., by a fastener 248 extending through holes 246 of sides 232 and hole 242 of forward end 239 of link 236).

In one or more arrangements, link 236 and lever 140 operate to move clamp assembly 172 inward and outward as lever 140 is rotated upward and downward about a pivot point formed by upper pivotal connection 152 of lever 140. In the arrangement shown, as one example, when lever 140 is rotated upward, lower pivotal connection 154 of lever 140 is moved downward and rearward, which moves rearward end 240 of link 236 downward and rearward, which causes forward end 238 of link 236 and main body 222 of clamp assembly 172 to be pulled rearward. Conversely, when lever 140 is rotated rearward, lower pivotal connection 154 of lever 140 is moved upward and forward, which moves rearward end 240 of link 236 upward and forward, which causes forward end 238 of link 236 and main body 222 of clamp assembly 172 to be pushed forward.

In the arrangement shown, main body 222 of clamp assembly 172 is formed of a pair of symmetric halves 252 that are operably connected together (e.g., by fasteners 254). However, the arrangements are not so limited. Rather, it is contemplated that in some arrangements, halves 252 and/or other components forming clamp assembly 172 may be connected to one another by any manner, method or means including but not limited to, for example fasteners (e.g., screws, bolts, pins, clips, etc.), clamps, press fitting, friction fitting, gluing, welding, adhering, or by any other manner, method or means or the like. Additionally or alternatively, in some arrangements, main body 222 and/or other components of clamp assembly 172 may be formed as a unitary body.

In one or more arrangements, clamp assembly 172 includes a pair of side covers 276 configured to attach to sides 232 of main body 222, for example, to cover fasteners 254 and provide an aesthetically pleasing appearance. In the arrangement shown, as one example, side covers 276 have a generally planar shape matching the shape of main block when viewed from the side. In this example arrangement, side covers 276 have a set of features 278 configured to connect with features 280 of main body 222 to facilitate connection of side covers 276 with main body 222. In the arrangement shown, features 278 and 280 are snap type features. However, the arrangements are not so limited. Rather, it is contemplated that in some arrangement side covers 276 may be connected with main body 222 by various types of features, method or means including but not limited to, for example fasteners (e.g., screws, bolts, pins, clips, etc.), clamps, snaps, connectors (e.g., latches, couplings, locks. etc.), press fittings, friction fittings, gluing, welding, adhering, or by any other manner, method or means or the like.

### Drill Guide Block 174:

In one or more arrangements, clamp and drill guide assembly 32 includes a drill guide block 174 operably connected to front 224 of main body 220 of clamp assembly 172. Drill guide block 174 is formed of any size, shape, and design and is configured to be attached to and removed from clamp and drill guide assembly 32 and includes a clamping face 260 and drill guides 262 having bores 264 therein that facilitate drilling of pocket holes in workpiece 24.

In the arrangement shown, as one example, drill guide block 174 includes a main body 226 having a clamping face 260 and an upper wall 314. Drill guides 262 having generally cylindrical bores 264 that extend there through extend at an angle through drill guide block 174 such that the bore 264 of drill guides 262 intersect upper wall 314 at their upper end and intersect clamping face 260 at their lower end.

In the arrangement shown, as one example, drill guide block 174 includes a set of features 270 configured to engage and connect with a set of features 272 of main body 220 of clamp assembly 172 to facilitate connection of drill guide block 174 with clamping assembly 38 clamp and drill guide assembly 32. In this example arrangement, features 270 are positioned adjacent the sides of drill guide block 174 and are configured to selectively connect with features 272 of clamping assembly 38 thereby holding drill guide block 174 onto clamping assembly 38. In the arrangement shown, as one example, features 272 of clamping assembly are operably connected with buttons 274 configured to disconnect features 272 from features 270 when depressed. In this manner, features 270 and 272 provide a quick and easy and convenient way for drill guide blocks 174 to easily be installed, removed, and/or replaced. In this manner, various drill guide blocks 174 may be swapped out to allow for the use of different drill guide blocks 174 for servicing, replacement or for different drill bit sizes, applications, and/or purposes.

### Self-Adjusting Pocket Hole Drilling:

In one or more arrangements, upright assembly 28 and clamp and drill guide assembly 32 are configured to provide self-adjusting clamping of workpieces 24 for drilling of pocket holes. It should be understood that the proper distance from an edge of workpiece 24 at which a pocket hole should be drilled (or height at which drill guide block 174 of clamp and drill guide assembly 32 should be positioned for drilling pocket holes) depends on the thickness of the workpiece 24. Generally speaking, as thickness of a workpiece 24 increases, pocket holes should be drilled further away from the edge of the workpiece 24. Conversely, as thickness of a workpiece 24 decreases, pocket holes should be drilled closer to the edge of the workpiece 24. In one or more arrangements, the position of drill guide block 174 relative to the edge of workpiece 24 may be adjusted by adjusting the height at which of clamp and drill guide assembly 32 is positioned along track 114 of upright assembly 28 when clamping of a workpiece 24.

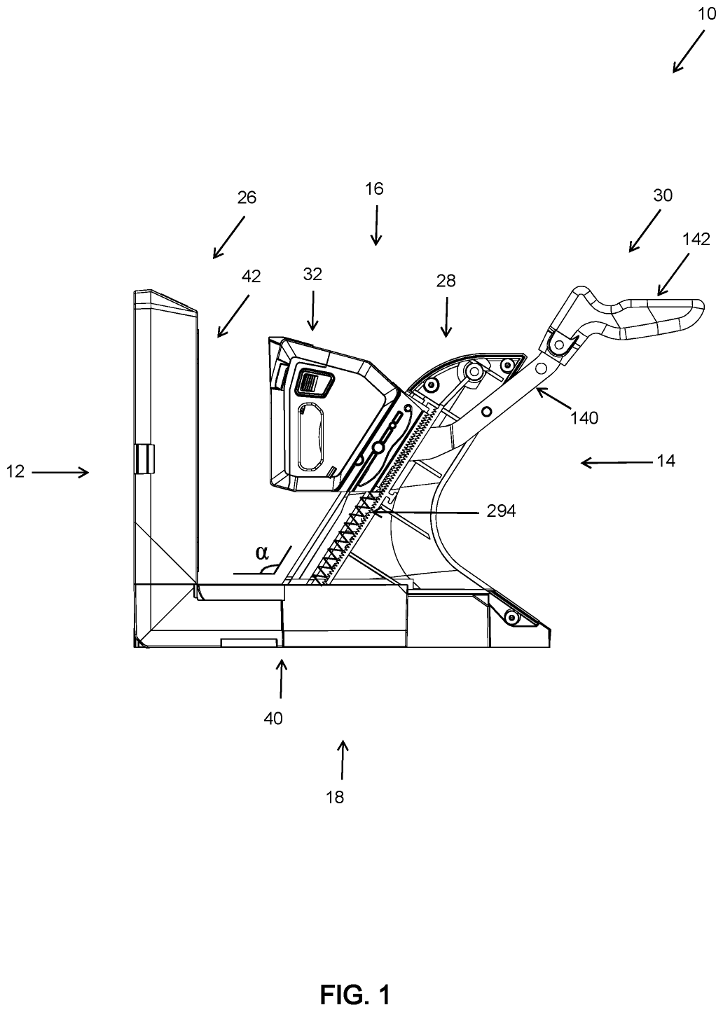

In one or more arrangements, upright assembly 28 and clamp and drill guide assembly 32 are configured to self-adjusting the height at which clamp and drill guide assembly 32 is positioned along track 114 when clamping of workpieces 24. In the arrangement shown, as one example, track 114 of upright assembly 28 is oriented at an angle (e.g., angle α in FIG. 1), sloping rearward from clamping surface 92 of backstop 42 of base 26 as upright assembly 28 extends upward from lower portion 40 of base 26, such that when a workpiece 24 is placed in system 10 against clamping surface 92 and clamp and drill guide assembly 32 is moved downward along track 114 to a point where clamping face 260 of drill guide block 174 contacts workpiece 24, the drill guide block 174 is positioned at an appropriate distance from a lower edge of the workpiece 24 for drilling a pocket hole for that particular thickness of workpiece.

As an illustrative example, to drill a pocket hole in a ½ inch thick workpiece 24, a user first places the workpiece 24 on upper surface 52 of lower portion 40 against clamping surface 92 of backstop 42. The user than uses handle 142 in a non-clamping position to move lever 140 of actuator assembly 30 downward, and thereby move clamp and drill guide assembly 32 downward along track 114 of upright assembly 28 until clamping face 260 of drill guide block 174 is placed in contact with workpiece 24. In such position, drill guide block 174 of clamp and drill guide assembly 32 is at the correct height to drill a pocket hole in the ½ inch thick workpiece 24. In this illustrative example, the user then clamps the workpiece 24 in place and locks clamp and drill guide assembly 32 in position along track 114 by rotating handle 142 of lever 140 of actuator assembly 30 rearward and downward from the non-clamping position to a clamping position. As upper end 146 of lever 140 is rotated rearward and downward, lower end 148 is rotated forward and upward, thereby causing link 236 to increase the separation between clamp assembly 172 and carrier 170 of clamp and drill guide assembly 32. As a result, carrier 170 is moved rearward, thereby causing ratchet mechanism 188 of carrier 170 to engage ratchet strips 124 of upright assembly 28 and lock clamp and drill guide assembly 32 in position along track 114. At the same time, drill guide block 174 is pressed forward, thereby clamping workpiece 24 between clamping face 260 of drill guide block 174 and clamping surface 92 of backstop 42.

In one or more arrangements, link 236 and actuator assembly 30 operated as an over-center latch to lock clamp and drill guide assembly 32 in a clamped position. For example, as previously noted, as upper end 146 of lever 140 is rotated rearward and downward, lower end 148 is rotated forward and upward, thereby causing link 236 to increase the separation between clamp assembly 172 and carrier 170 of clamp and drill guide assembly 32. Link 236 continues to increase the separation until link 236 is positioned in line with lower end 138 of lever 140. In one or more arrangements, actuator assembly 30 permits a user to further rotate upper end 146 of lever 140 a bit further rearward and downward to a point at which link 236 slightly decreases separation between clamp assembly 172 and carrier 170. In this position, compressive forces placed on link 236 by the clamping hold actuator assembly 30, link 236, and other components of clamp and drill guide assembly 32 in place, thereby locking workpiece 24 in a clamped position for drilling of a pocket hole.

When drilling of a pocket hole is completed, the workpiece 24 may be unclamped by simply using handle 142 to rotate upper end 146 of lever 140 upward and forward, thereby rotating lower end 148 of lever 140 out of the over-center lock position and downward and rearward, and thereby reducing separation between clamp assembly 172 and carrier 170 of clamp and drill guide assembly 32. As the separation between clamp assembly 172 and carrier 170 is reduced carrier 170 is moved forward by bias member 186 of carrier 170 until ratchet mechanism 188 of carrier 170 disengages from ratchet strips 124 of upright assembly 28. Once disengaged, clamp and drill guide assembly 32 can move upward along track 114.

### Bias Assembly 290:

In one or more arrangements, system 10 includes a bias assembly 290. Bias assembly 290 may be formed of any suitable size, shape, and design and is configured to move lever 140 of upright assembly 28 and clamp and drill guide assembly 32 to a fully raised position in absence of an opposing force.

In one or more arrangements, bias assembly 290 includes a first spring 292 configured to rotate upper end 146 of lever 140 of actuator assembly 30 upward and forward to a non-clamping position in absence of an opposing force. In the arrangement shown, as one example, spring 292 is an extension spring operably connected to clamp assembly 172 and carrier 170 of clamp and drill guide assembly 32. In this example arrangement, spring 292 is configured to apply a bias force to pull clamp assembly 172 and carrier 170 toward one another. When lever 140 of actuator assembly 30 is released from an over-center clamped position by a user, spring 292 pulls clamp assembly 172 and carrier 170 toward one another, which causes upper end 146 of lever 140 of actuator assembly 30 to be rotated upward and forward to the non-clamping position.

In one or more arrangements, bias assembly 290 includes a second spring 294 configured to move clamp and drill guide assembly 32 upward along track 114 to the fully raised position in absence of an opposing force. In the arrangement shown, as one example, spring 294 is a compression spring operably connected between base 26 and clamp and drill guide assembly 32. In this example arrangement, in absence of an opposing force, spring 294 is configured to push clamp and drill guide assembly 32 upward along track 114 to the fully raised position.

However, the arrangements are not so limited. Rather, it is contemplated that in some various arrangements, bias members 186 may be implemented using various methods and/or means including but not limited to, for example, springs (e.g., compression springs, leaf springs and/or other flat springs, torsion springs, extension springs, air springs, and/or other types of springs), compressible materials, and/or any other method and/or means of biasing.

### Debris Removal & Vacuum Attachment:

In one or more arrangements, clamp and drill guide assembly 32 includes one or more passageways to facilitate removal of wood chips, dust, and debris from drill guide block 174 that are generated when drilling of pocket holes. In the arrangement shown, as one example, main body 222 and side covers 276 of clamp assembly 172 clamp and drill guide assembly 32 include an opening 284 that extends through clamp and drill guide assembly 32 (e.g., thorough clamp assembly 172 and/or through drill guide block 174) from side-to-side. That is, in the arrangement shown, as one example, opening 284 generally square or rectangular in shape when viewed from the side and extends in approximately a consistent and continuous manner through drill guide assembly from side-to-side. However, any other size, shape or configuration of opening 284 is hereby contemplated for use.

In the arrangement shown, as one example, a passageway 286 extends from front 224 of main body 220 of clamp assembly 172 to opening 284. In the arrangement shown, the forward end of passageway 286 connects to a passageway 288 (not shown) of bores 264 of drill guide block 174. When drilling of pocket holes, resulting wood chips, dust, and debris is transported from bores 264 through passageway 288, through passageway 286, and out through opening 284 to exit system 10. However, the arrangements are not so limited. Rather, it is contemplated that in some arrangements, may utilize various alternative and/or additional methods and/or means for removal of wood chips, dust, and debris.

In one or more arrangements, system 10 includes a vacuum attachment 310 to facilitate removal of woodchips, dust, and debris. Vacuum attachment 310 may be formed of any size, shape, and design and is configured to be attached to and removed from clamp and drill guide assembly 32 and facilitates the removal of woodchips, dust and debris generated during drilling from the drill guide assembly 32 and drill guide block 174.

In the arrangement shown, as one example, vacuum attachment 310 includes an end wall 312 that connects at its upper and lower ends to upper and lower walls 314. End wall 324 also connects at its forward and rearward ends to forward and rearward walls 316. In the arrangement shown, as one example, end wall 312 is generally square or rectangular in shape. In the arrangement shown, as one example, upper and lower walls 314 extend in approximate parallel spaced relation to one another, and upper and lower walls 314 extend in approximate perpendicular alignment to end wall 312. In the arrangement shown, as one example, forward and rearward walls 316 extend in approximate parallel spaced relation to one another, and forward and rearward walls 316 extend in approximate perpendicular alignment to end wall 312. In the arrangement shown, as one example, upper and lower walls 314 extend in approximate perpendicular alignment to forward and rearward walls 316. In this way, the combination of end wall 312, upper and lower walls 314 and forward and rearward walls 316 form a generally square or rectangular shaped member that is configured to fit within opening 284 of clamp and drill guide assembly 32.

The end of upper and lower walls 314 and forward and rearward walls 316 opposite end wall 312 is connected to a neck section 318 that is connected to a collar section 320. Neck section 318 extends in a direction away from end wall 312 and smoothly converts the generally square or rectangular configuration of upper and lower walls 314 and forward and rearward walls 316 to the generally cylindrical shape of collar section 320. Collar section 320 is a generally elongated cylindrical shaped member that is configured to receive the end of a conventional vacuum. In this way, vacuum attachment 310 forms a generally hollow member.

In the arrangement shown, as one example, one of or both of forward and rearward walls 316 include a plurality of openings 322 therein that enable the entry of woodchips, dust and debris into the hollow interior of vacuum attachment 310 which are then removed under vacuum by a vacuum attached to collar section 320. In an alternative arrangement, one of or both of forward and rearward walls 316 are partially or wholly open thereby allowing unrestricted entry of woodchips, dust and debris into the hollow interior of vacuum attachment 310.

In the arrangement shown, as one example, the end of vacuum attachment 310 having end wall 312 is configured to be inserted into the opening 284 in either of the sides 232 of clamp assembly 172 of clamp and drill guide assembly 32. That is, vacuum attachment 310 and clamp and drill guide assembly 32 is ambidextrous. Once vacuum attachment 310 is fully inserted into opening 284, the end wall 312 covers opening 284 on the side 232 of clamp assembly 172 that is opposite the side 232 of insertion of the vacuum attachment 310. Once vacuum attachment 310 is fully inserted into opening 284, vacuum attachment 310 is in position to receive woodchips, dust and debris generated during drilling of pocket holes.

That is, during drilling of pocket holes, a drill bit is inserted within the bore 264 of at least one drill guide 262 of drill guide block 174. As the pocket hole is being drilled, woodchips, dust and debris are generated. The woodchips, dust and debris generated during drilling passes from bore 264, through passageway 288 in drill guide block 174, through passageway 286 in clamp and drill guide assembly 32 and through the forward wall 316 of vacuum attachment 310. The woodchips, dust and debris then travel through neck section 318, through collar section 320 and out of vacuum attachment 310 under vacuum by an attached vacuum. In this way, a clean, effective, convenient way of removing woodchips, dust and debris from clamp and drill guide assembly 32.

Notably, as the clamp and drill guide assembly 32 and drill guide block 174 travel along the angled upright assembly 28 between a lowered position and a raised position, vacuum attachment 310 travels with the clamp and drill guide assembly 32 and drill guide block 174.

Some embodiments may utilize other sizes, shapes and/or designs to implement the vacuum attachment 310. In one or more embodiments, instead of inserting vacuum attachment 310 into opening 284, vacuum attachment 310 is not inserted into opening 284. In one or more arrangements, vacuum attachment 310 attaches to the exterior of clamp and drill guide assembly 32 and covers one of the openings 284 while the other opening 284 may be covered, the other opening 284 may be left open, or the other opening 284 may not be present and instead only a single opening 284 is present.

### Grippy Material 328:

In one or more arrangements, some or all of the surfaces of system 10 that engage workpiece 24 are partially or wholly covered by a compressible material that has a high coefficient of friction or a non-compressible material that has a high coefficient of friction. This material with a high coefficient of friction is referred to herein as a grippy material 328 (not shown) and helps to hold workpiece 24 in place within system 10 as well as reduces the amount of clamping pressure required to adequately hold workpiece 24 in place. This is because grippy material 328 has a high coefficient of friction making it less likely that workpiece 24 will slide or shift after being clamped and during the drilling process.

In one or more arrangements, grippy material 328 with a high coefficient of friction covers some or the entire upward facing upper surface 52 of lower portion 40 of base 26, the rearward facing clamping surface 92 of backstop 42 of base 26 and/or the clamping face 260 of drill guide block 174. The entirety of these surfaces may be covered by a grippy material 328 or alternatively only a portion of these surfaces may be covered by a grippy material 328. The grippy material 328 may be added on top of these surfaces by gluing, adhering, spraying, sticking or otherwise by adding the grippy material 328 by any other manner, method or means. Alternatively, the grippy material 328 may be formed into these surfaces during manufacturing such as through dual durometer molding or otherwise by adding the grippy material 328 by any other manner, method or means.

### Objectives Met:

In this way the system 10 is used to form pocket hole and all of the objectives of the disclosure are met. That is, the self-adjusting pocket hole jig system presented herein: improves upon the state of the art; is easy to use; is efficient; can be used with any type of workpiece; is cost effective; forms accurate pocket holes; is safe to use; has a durable design; has a long useful life; provides additional functionality for pocket hole jigs and pocket hole joinery; has a wide variety of uses; has a wide variety of applications; provides cost savings to a user; is relatively inexpensive; provides value; prevents or reduces relative movement between the pocket hole jig and the workpiece; reduces the amount of clamping pressure required to adequately clamp a pocket hole jig to a workpiece; facilitates the formation of aesthetically pleasing finished products; provides a clamping with movement of the handle in a single plane; facilitates easier clamping; facilitates raising and lowering of the drill guide assembly with movement of the handle in a single plane; facilitates easy release of the clamping mechanism; facilitates easy return of the clamping mechanism to a non-clamping position; facilitates easy adjustment of the clamping pressure; facilitates stable placement when used horizontally; facilitates stable placement when used vertically; facilitates easy removal of chips and debris during use; is comfortable to use; is more stable than other pocket hole jigs; facilitates automatic return of the clamping assembly to a non-clamping position; facilitates spring loaded return of the clamping assembly to a non-clamping position; improves the ergonomics of use; easily adjusts to workpieces of various thickness; adjusts the drill guide assembly to the optimum position for each workpiece; consistently applies the same clamping pressure regardless of workpiece thickness, improves the intuitiveness of drilling pocket hole jigs; improves the usability of pocket hole jigs; reduces set-up time; provides a single touch point for clamping and adjusting the position of the drill guide assembly; provides convenient woodchip, dust and debris removal; provides easy removal and replacement of drill guide blocks, among countless other features and benefits.

Although specific embodiments have been illustrated and described herein, it will be appreciated by those of ordinary skill in the art that other arrangements calculated to achieve the same purpose may be substituted for the specific embodiments shown. This application is intended to cover any adaptations or variations of the disclosed embodiments. It is intended that this disclosure be limited only by the following claims, and the full scope of equivalents thereof. To be clear, the term “operatively”, as used in the claims, such as when a claim states “operably connected” or “connected in an operable manner” or similar language is intended to mean connected by any manner, method or means, including directly connected, indirectly connected, connected by intervening or intermediary parts, pieces or components, connected as separate components, connected as a single component, or connected in any manner that facilitates operation. In this way, the term “operatively” is intended to be broadly interpreted as connected in any way and does not require direct connection but may include a direct connection and may include being formed of a single member or formed of a plurality of members that are connected to one another. A direct connection between two parts or components is only required when a claim states “directly connected” “directly engaged” “connected directly to” or similar language.

What is claimed:

1. A pocket hole jig system, comprising;
a base;
an upright assembly operably connected to the base;
a drill guide and clamping assembly operably connected to the upright assembly;
an actuator assembly operably connected to the drill guide and clamping assembly;
the actuator assembly having a handle;
wherein the handle is moveable between a raised position and a lowered position;
the drill guide and clamping assembly having a drill guide block;
wherein the drill guide block has a clamping face;
wherein the drill guide block has a plurality of drill guides having corresponding bores that intersect the clamping face;
wherein the upright assembly has a track;
wherein when the handle of the actuator assembly of rotatable between a non-clamping position and a clamping position;
wherein when the handle is in the non-clamping position, the drill guide and clamping assembly is movable along the track of the upright assembly to adjust height of the drill guide block for drilling of a pocket hole in a workpiece;
wherein when the handle is moved to the clamping position, the drill guide and clamping assembly is configured to lock the drill guide and clamping assembly in position along the track of the upright assembly; and
wherein when the handle is moved to the clamping position, the drill guide and clamping assembly is configured to move the drill guide block forward to facilitate clamping of the workpiece.

2. The system of claim 1, wherein the base has a lower portion and a backstop, wherein the backstop is positioned opposite the upright assembly.

3. The system of claim 1, wherein the upright assembly extends upward and rearward from the base at an angle such that, when the drill guide and clamping assembly is attached to the drill guide assembly, the drill guide and clamping assembly moves downward and forward toward a workpiece when the handle with moved downward in the non-clamping position.

4. The system of claim 1, wherein a workpiece is clamped between a backstop of the base and a clamping face of the drill guide block.

5. The system of claim 1, wherein the drill guide and clamping assembly includes a clamping assembly operably connected with the drill guide block;
the clamping assembly configured to move the drill guide block forward to facilitate clamping of the workpiece when the handle is moved to the clamping position.

6. The system of claim 1, wherein the drill guide and clamping assembly includes a clamping assembly operably connected with the drill guide block;
the clamping assembly configured to move the drill guide block forward to facilitate clamping of the workpiece when the handle is moved to the clamping position;
the clamping assembly including a linkage assembly that clamps a workpiece in an over-center condition.

7. The system of claim 1, wherein the drill guide and clamping assembly includes a carriage assembly and a clamping assembly;
wherein the carriage assembly is configured to operably connect with the track of the upright assembly;
wherein the clamping assembly is configured to operable connect the drill guide block with the carriage assembly;
wherein the clamping assembly configured to increase separation between the drill guide block and the carriage assembly when the handle is moved to the clamping position, thereby moving the drill guide block forward to facilitate clamping of the workpiece;
wherein the clamping assembly configured to decrease separation between the drill guide block and the carriage assembly when the handle is moved to the non-clamping position, thereby moving the drill guide block rearward to facilitate unclamping of the workpiece.

8. The system of claim 1, wherein the drill guide and clamping assembly includes a carriage assembly and a clamping assembly;
wherein the carriage assembly is configured to operably connect with the track of the upright assembly;
wherein the clamping assembly is configured to operable connect the drill guide block with the carriage assembly;
wherein the clamping assembly configured to increase separation between the drill guide block and the carriage assembly when the handle is moved to the clamping position, thereby moving the drill guide block forward to facilitate clamping of the workpiece;
wherein when separation between the drill guide block and the carriage assembly is increased during clamping, the carriage assembly is moved rearward causing the carriage assembly to engage with one or more features of the upright assembly to lock the carriage assembly in position along the track.

9. The system of claim 1, wherein the drill guide and clamping assembly includes a carriage assembly and a clamping assembly;
wherein the carriage assembly is configured to operably connect with the track of the upright assembly;
wherein the clamping assembly is configured to operable connect the drill guide block with the carriage assembly;
wherein the clamping assembly configured to increase separation between the drill guide block and the carriage assembly when the handle is moved to the clamping position, thereby moving the drill guide block forward to facilitate clamping of the workpiece;
wherein when separation between the drill guide block and the carriage assembly is increased during clamping, the carriage assembly is moved rearward causing the carriage assembly to engage a ratchet strip of the upright assembly to lock the carriage assembly in position along the track.

10. The system of claim 1, wherein when the handle is in the non-clamping position, the drill guide and clamping assembly is movable along the track of the upright assembly between a fully raised position and a fully lowered position to adjust height of the drill guide block for drilling of a pocket hole in the workpiece;
further comprising a spring wherein the spring facilitates automatic return of the drill guide assembly to the fully raised position in absence of an opposing force.

11. The system of claim 1, further comprising a spring wherein the spring facilitates automatic return of the handle of the actuator to the non-clamping position.

12. The system of claim 1, wherein when the handle is in the non-clamping position, the drill guide and clamping assembly is movable along the track of the upright assembly between a fully raised position and a fully lowered position to adjust height of the drill guide block for drilling of a pocket hole in the workpiece;
further comprising:
a first spring wherein the first spring facilitates automatic return of the drill guide assembly to the fully raised position in absence of an opposing force;
a second spring wherein the second spring facilitates automatic return of the handle of the actuator to the non-clamping position.

13. The system of claim 1, wherein a user moves the handle downward while in the non-clamping position to move the drill guide and clamping assembly along the track of the upright assembly to adjust the height of the drill guide block, based on thickness of a workpiece, as well as to clamp the workpiece.

14. The system of claim 1, wherein a user moves the handle downward while in the non-clamping position to automatically lower the drill guide block to the appropriate height for workpieces of different thicknesses.

15. The system of claim 1, wherein movement of the drill guide and clamping assembly along the track of the upright assembly downward along the track of the upright assembly automatically moves the drill guide block to a corresponding forward position for a workpiece based on thickness of the workpiece.

16. The system of claim 1, wherein movement of the handle from the non-clamping position to the clamping position automatically applies approximately a set clamping pressure on workpieces of different thickness.

17. The system of claim 1, wherein the handle moves in a single plane to facilitate clamping as well as unclamping of the workpiece.

18. The system of claim 1, wherein the drill guide assembly includes an opening that receives a dust collection member that facilitates removal of woodchips, dust and debris generated during drilling.

19. A method of forming pocket holes, the steps comprising;
providing a pocket hole jig having a base with a lower portion and a backstop, an upright assembly operably connected to the base, a drill guide and clamping assembly operably connected to the upright assembly, the drill guide and clamping assembly having a drill guide block, and an actuator assembly having a handle;
placing a workpiece having a thickness between the backstop of the base and the drill guide block;
with the handle in a non-clamping position, moving the handle from raised position to a lowered position to move the drill guide and clamping assembly downward and forward along a track of the upright assembly until a clamping surface of the drill guide block is placed into contact with the workpiece;
wherein moving the drill guide and clamping assembly downward and forward along a track of the upright assembly until the clamping surface of the drill guide block contacts the workpiece automatically positions the drill guide block at a height for drilling of a pocket hole based on the thickness of the workpiece;
rotating the handle from the non-clamping position to a clamping position to lock the drill guide and clamping assembly in position along the upright assembly.

20. The method of claim 19, wherein the rotating the handle from the non-clamping position to the clamping position causes the drill guide block to be moved forward toward the workpiece to facilitate clamping of the workpiece between the drill guide block and the backstop of the base.

21. The method of claim 19, further comprising the step of drilling at least one pocket hole in the workpiece by inserting a drill bit through a bore of the drill guide block after the workpiece is clamped.

22. The method of claim 19, further comprising the steps of:
drilling at least one pocket hole in the workpiece by inserting a drill bit through a bore of the drill guide block in the drill guide assembly after the workpiece is clamped;
moving the handle from the clamping position to the non-clamping position after at least one pocket hole is drilled in the workpiece thereby causing the clamp and drill guide assembly to move along the upright assembly upward and away from the workpiece and the backstop thereby disengaging the workpiece.

23. The method of claim 19, further comprising the steps of:
drilling at least one pocket hole in the workpiece by inserting a drill bit through a bore of the drill guide block in the drill guide assembly after the workpiece is clamped;
unclamping the workpiece after the at least one pocket hole is drilled in the workpiece by moving the handle from the clamping position to the non-clamping position, thereby causing the drill guide assembly to move along the upright assembly upward and away from the workpiece and the backstop.

24. A pocket hole jig system, comprising;
a base;
an upright assembly operably connected to the base;
a drill guide and clamping assembly operably connected to the upright assembly;
an actuator assembly operably connected to the drill guide and clamping assembly;
the actuator assembly having a handle;
wherein the handle is moveable between a raised position and a lowered position;
the drill guide and clamping assembly having a drill guide block;
wherein the drill guide block has a clamping face;
wherein the drill guide block has a plurality of drill guides having corresponding bores that intersect the clamping face;
wherein the upright assembly has a track;
wherein when the handle of the actuator assembly of rotatable between a non-clamping position and a clamping position;
wherein when the handle is in the non-clamping position, the drill guide and clamping assembly is movable along the track of the upright assembly to adjust height of the drill guide block for drilling of a pocket hole in a workpiece;
wherein the upright assembly extends upward and rearward from the base at an angle such that, when the drill guide and clamping assembly is attached to the drill guide assembly, the drill guide and clamping assembly moves downward and forward toward a workpiece when the handle with moved downward in the non-clamping position from the raised position to the lowered position;
wherein when the handle is moved to the clamping position, the drill guide and clamping assembly is configured to lock the drill guide and clamping assembly in position along the track of the upright assembly; and
wherein when the handle is moved to the clamping position, the drill guide and clamping assembly is configured to move the drill guide block forward to facilitate clamping of the workpiece.
